(19) United States
(12) Patent Application Publication
(10) Pub. No.: US 2025/0085403 A1
(43) Pub. Date: Mar. 13, 2025

(54) CONTROL DEVICE, SENSING SYSTEM, CONTROL METHOD AND NON-TRANSITORY COMPUTER READABLE MEDIUM STORING CONTROL PROGRAM

(71) Applicant: DENSO CORPORATION, Kariya-city (JP)

(72) Inventor: Tomonari YOSHIDA, Kariya-city (JP)

(21) Appl. No.: 18/955,120

(22) Filed: Nov. 21, 2024

Related U.S. Application Data
(63) Continuation of application No. PCT/JP2023/021498, filed on Jun. 9, 2023.

(30) Foreign Application Priority Data
Jun. 30, 2022 (JP) 2022-105557

(51) Int. Cl. G01S 7/4863; G01S 7/481; G01S 17/931

(52) U.S. Cl. CPC G01S 7/4863; G01S 7/4817; G01S 17/931

(57) ABSTRACT

Disclosed is a technique for controlling an optical sensor that receives reflected light in response to light irradiation along each scanning line which moves in a scanning direction within a scanning frame. In the technique, a region of interest is shifted between two successive scanning frames. The region of interest is a region from which light receiving data is read for each scanning line, and corresponds to N rows of light receiving elements stacked in the scanning direction in the optical sensor, where N is an integer greater than or equal to 2. The region of interest for each scanning line is shifted by N−1 or fewer rows of light receiving elements between two successive scanning frames. Sensing data is outputted by integrating the light receiving data of each scanning line retrieved from current and previous N−1 scanning frames.

### CROSS REFERENCE TO RELATED APPLICATIONS

The present application is a continuation application of International Patent Application No. PCT/JP2023/021498 filed on Jun. 9, 2023, which designated the U.S. and claims the benefit of priority from Japanese Patent Application No. 2022-105557 filed on Jun. 30, 2022. The disclosures of all the above applications are incorporated herein.

### TECHNICAL FIELD

The present disclosure relates to a control technology for controlling an optical sensor that receives reflected light in response to light irradiation.

### BACKGROUND

In control of an optical sensor, each scanning region includes first and second addition regions partially that overlap each other as addition regions in which light receiving data is combined.

### SUMMARY

At least one embodiment of the present disclosure is a technique for controlling an optical sensor that receives reflected light in response to light irradiation along each scanning line which moves in a scanning direction within a scanning frame. In the technique, a region of interest is shifted between two successive scanning frames. The region of interest is a region from which light receiving data is read for each scanning line, and corresponds to N rows of light receiving elements stacked in the scanning direction in the optical sensor, where N is an integer greater than or equal to 2. The region of interest for each scanning line is shifted by N−1 or fewer rows of light receiving elements between two successive scanning frames. Sensing data is outputted by integrating the light receiving data of each scanning line retrieved from current and previous N−1 scanning frames.

### BRIEF DESCRIPTION OF THE DRAWINGS

The details of one or more embodiments are set forth in the accompanying drawings and the description below. Other features and advantages will be apparent from the description and drawings, and from the claims.

FIG. 1 is a block diagram showing an overall configuration of a sensing system according to a first embodiment.

FIG. 2 is a cross-sectional view showing a detailed configuration of an optical sensor according to the first embodiment.

FIG. 3 is a time chart illustrating control of the optical sensor according to the first embodiment.

FIG. 4 is a plan view showing a configuration of a light receiving unit according to the first embodiment.

FIG. 5 is a block diagram showing a functional configuration of a control device according to the first embodiment.

FIG. 6 is a time chart illustrating the control of the optical sensor according to the first embodiment.

FIG. 7 is a time chart illustrating the control of the optical sensor according to the first embodiment.

FIG. 8 is a time chart illustrating the control of the optical sensor according to the first embodiment.

FIG. 9 is a time chart illustrating the control of the optical sensor according to the first embodiment.

FIG. 10 is a time chart illustrating the control of the optical sensor according to the first embodiment.

FIG. 11 is a schematic diagram illustrating the control of the optical sensor according to the first embodiment.

FIG. 12 is a schematic diagram illustrating the control of the optical sensor according to the first embodiment.

FIG. 13 is a schematic diagram illustrating the control of the optical sensor according to the first embodiment.

FIG. 14 is a schematic diagram illustrating the control of the optical sensor according to the first embodiment.

FIG. 15 is a schematic diagram illustrating the control of the optical sensor according to the first embodiment.

FIG. 16 is a flowchart showing a control flow of the optical sensor according to the first embodiment.

FIG. 17 is a cross-sectional view showing a detailed configuration of an optical sensor according to a second embodiment.

FIG. 18 is a block diagram showing a functional configuration of a control device according to the second embodiment.

FIG. 19 is a schematic diagram illustrating control of the optical sensor according to the second embodiment.

FIG. 20 is a schematic diagram illustrating the control of the optical sensor according to the second embodiment.

FIG. 21 is a schematic diagram illustrating the control of the optical sensor according to the second embodiment.

FIG. 22 is a time chart illustrating control of an optical sensor according to a third embodiment.

FIG. 23 is a time chart illustrating the control of the optical sensor according to the third embodiment.

FIG. 24 is a time chart illustrating the control of the optical sensor according to the third embodiment.

FIG. 25 is a time chart illustrating the control of the optical sensor according to the third embodiment.

FIG. 26 is a time chart illustrating the control of the optical sensor according to the third embodiment.

FIG. 27 is a time chart illustrating the control of the optical sensor according to the third embodiment.

FIG. 28 is a time chart illustrating the control of the optical sensor according to the third embodiment.

FIG. 29 is a cross-sectional view showing a detailed configuration of an optical sensor according to a fourth embodiment.

FIG. 30 is a block diagram showing a functional configuration of a control device according to the fourth embodiment.

FIG. 31 is a schematic diagram illustrating control of the optical sensor according to the fourth embodiment.

FIG. 32 is a schematic diagram illustrating the control of the optical sensor according to the fourth embodiment.

FIG. 33 is a schematic diagram illustrating the control of the optical sensor according to the fourth embodiment.

FIG. 34 is a schematic diagram illustrating the control of the optical sensor according to the fourth embodiment.

### DETAILED DESCRIPTION

In the control technique according to a comparative example, each scanning region includes first and second addition regions partially that overlap each other as addition regions in which light receiving data is combined. Accordingly, scanning in the first addition region and scanning in the second addition region are continuously performed on the same scanning region.

In the control technique according to the comparative example, addition data of the light receiving data is generated for each of the two types of addition regions which have partially overlapped parts due to shift from each other on the same scanning region, and a resolution can be increased by adjusting the shift. In a single scanning frame where all the scanning regions are scanned, a scanning time required to complete all scans in the respective addition regions is increased, leading to a reduced frame rate. Higher frame rate and resolution result in greater sensing accuracy.

The present disclosure can provide a technique for controlling an optical sensor, which can improve sensing accuracy.

According to a first aspect of the present disclosure, a control device is configured to control an optical sensor that receives reflected light in response to light irradiation along each scanning line which moves in a scanning direction within a scanning frame. The control device includes a processor configured to carry out shifting a region of interest between two successive scanning frames. The region of interest is a region from which light receiving data is read for each scanning line. The region of interest corresponds to N rows of light receiving elements stacked in the scanning direction in the optical sensor, where N is an integer greater than or equal to 2. The shifting of the region of interest is shifting the region of interest for each scanning line by N−1 or fewer rows of light receiving elements between two successive scanning frames. The processor is further configured to carry out outputting sensing data by integrating the light receiving data of each scanning line retrieved from current and previous N−1 scanning frames.

According to a second aspect of the present disclosure, a sensing system includes an optical sensor configured to receive reflected light in response to light irradiation along each scanning line which moves in a scanning direction within a scanning frame, and the control device according to the first aspect and configured to control the optical sensor.

According to a third aspect of the present disclosure, a control method is to be executed by a processor for controlling an optical sensor configured to receive reflected light in response to light irradiation along each scanning line which moves in a scanning direction within a scanning frame. The method includes shifting a region of interest between two successive scanning frames. The region of interest is a region from which light receiving data is read for each scanning line. The region of interest corresponds to N rows of light receiving elements stacked in the scanning direction in the optical sensor, where N is an integer greater than or equal to 2. The shifting of the region of interest is shifting the region of interest for each scanning line by N−1 or fewer rows of light receiving elements between two successive scanning frames. The method further includes outputting sensing data by integrating the light receiving data of each scanning line retrieved from current and previous N−1 scanning frames.

According to a fourth aspect of the present disclosure, a non-transitory computer readable medium stores control program to control an optical sensor configured to receive reflected light in response to light irradiation along each scanning line which moves in a scanning direction within a scanning frame. The control program includes commands configured to, when executed by a processor, cause the processor to carry out shifting a region of interest between two successive scanning frames. The region of interest is a region from which light receiving data is read for each scanning line. The region of interest corresponds to N rows of light receiving elements stacked in the scanning direction in the optical sensor, where N is an integer greater than or equal to 2. The shifting of the region of interest is shifting the region of interest for each scanning line by N−1 or fewer rows of light receiving elements between two successive scanning frames. The commands are further configured to, when executed by the processor, cause the processor to carry out outputting sensing data by integrating the light receiving data of each scanning line retrieved from current and previous N−1 scanning frames.

As described above, in the first to fourth aspects, the light receiving data is read from the region of interest of each scanning line within each scanning frame where the scanning line moves in the scanning direction. The region of interest corresponds to the N rows of light receiving elements stacked in the scanning direction in the optical sensor while N is defined as the integer equal to or greater than 2, and the region of interest is a region from which the light receiving data is read for each scanning line. The region of interest is shifted by N−1 or fewer rows of the light receiving elements between two successive scanning frames. According to this, the scanning time required to read out the light receiving data while shifting the region of interest for each scanning line corresponds to the time for each scanning frame and can therefore be shortened as much as possible.

According to the first to fourth embodiments, the light receiving data read from the region of interest for each scanning line within each scanning frame is integrated across the current and previous (N−1) scanning frames and is output as sensing data. Consequently, in the sensing data produced by integrating the light receiving data from the region of interest for each scanning line per scanning frame, the resolution can be enhanced based on the shift of the region of interest between successive scanning frames.

In the first to fourth embodiments as described above, it is possible to achieve both an increased frame rate by reducing the scanning time for each scanning frame and an enhanced resolution by increasing the resolution of the output sensing data. Therefore, it is possible to increase the sensing accuracy.

Hereinafter, multiple embodiments for implementing the present disclosure will be described referring to drawings. Among the embodiments, parts that correspond to each other may be assigned the same reference numeral, and redundant explanation for the part may be omitted. When only a part of a configuration is described in an embodiment, explanations of the other parts of the configuration described in another preceding embodiment may be used. Parts may be combined among the embodiments even if it is not explicitly described that the parts can be combined. The embodiments may be partially combined even if it is not explicitly described that the embodiments can be combined, provided there is no harm in the combination.

### First Embodiment

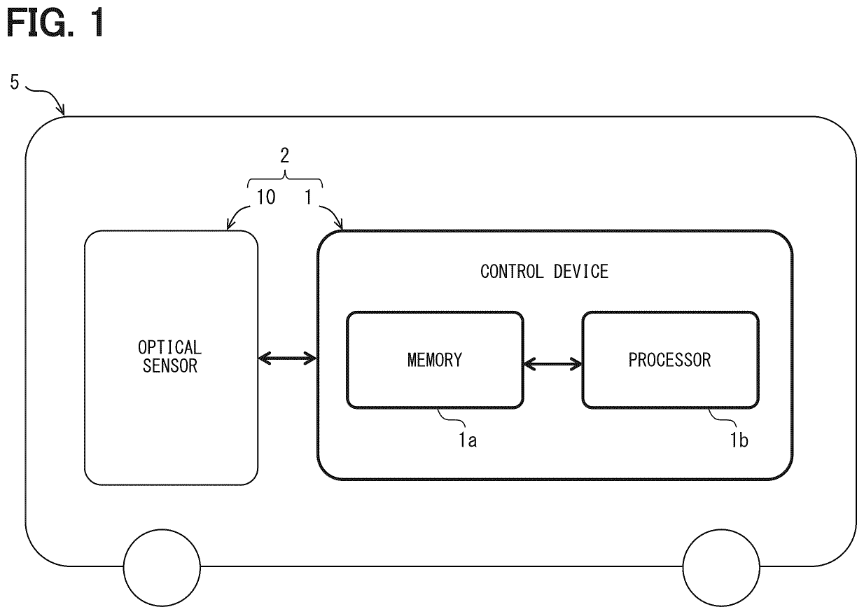

As shown in FIG. 1, a first embodiment of the present disclosure relates to a sensing system 2 including an optical sensor 10 and a control device 1. The sensing system 2 is mounted on a vehicle 5. The vehicle 5 is, for example, a moving object such as an automatic vehicle capable of traveling on a traveling road when an occupant is on the vehicle.

The vehicle 5 is capable of traveling automatically constantly or temporarily in an autonomous driving control mode. Here, the autonomous driving control mode may be achieved by autonomous driving control, such as conditional driving automation, altitude driving automation, or full driving automation, in which a system performs all driving tasks when activated. The autonomous driving control mode may be achieved in advanced driver-assistance control, such as driving assistance or partial driving automation, in which the occupant performs some or all of the driving tasks. The autonomous driving control mode may be achieved by either one, a combination, or switching of the autonomous driving control and the advanced driver-assistance control.

In the following description, unless otherwise noted, front, rear, up, down, left, and right directions are defined with reference to the vehicle 5 on a horizontal plane. The horizontal direction indicates a direction parallel to a horizontal plane serving as a direction reference of the vehicle 5. A vertical direction indicates a direction perpendicular to the horizontal plane serving as the direction reference of the vehicle 5, which is also an up-down direction.

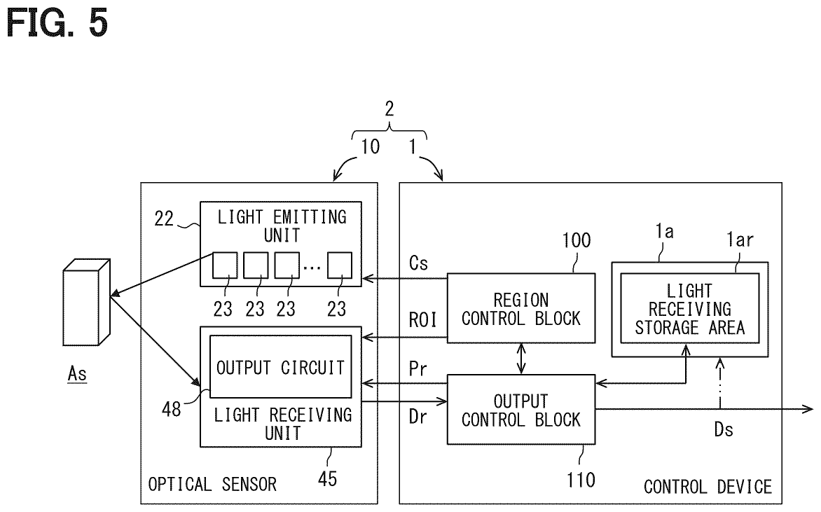

The optical sensor 10 is a so-called light detection and ranging/laser imaging detection and ranging (LiDAR) for acquiring sensing data Ds (see FIG. 5 to be described later) that can be used for driving control of the vehicle 5 including an autonomous control driving mode. The optical sensor 10 is disposed in at least one of a front portion, left and right side portions, a rear portion, and an upper roof of the vehicle 5.

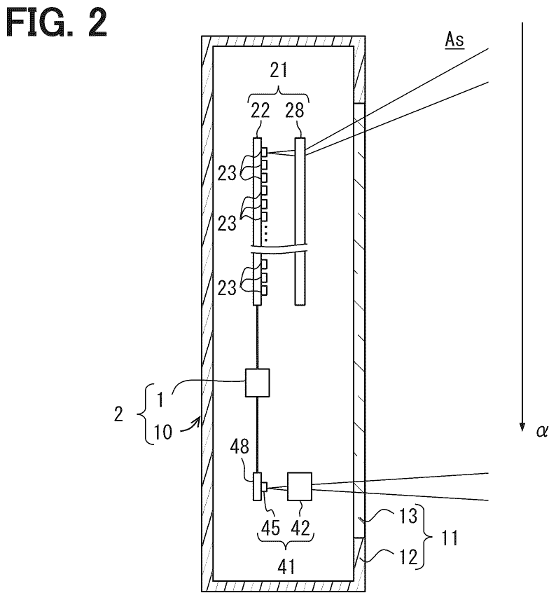

The optical sensor 10 emits light toward a sensing area As (see FIGS. 2 and 5 to be described later) corresponding to an arrangement position and a viewing angle in an external space of the vehicle 5. The optical sensor 10 receives reflected light that is incident when the irradiated light is reflected from the sensing area As. In response to the reception of the reflected light with respect to the irradiation light, the optical sensor 10 senses a target that reflects the light in the sensing area As. In particular, the sensing in the present embodiment means that, among a reflection point distance from the optical sensor 10 to the target and a reflection intensity from the target, at least the former is measured.

A typical sensing target object in the optical sensor 10 applied to the vehicle 5 may be at least one of moving objects such as a pedestrian, a cyclist, an animal other than a human, and other vehicles. The typical sensing target object in the optical sensor 10 applied to the vehicle 5 may be at least one type of stationary objects such as a guardrail, a road sign, a structure beside a road, and a fallen object on a road.

As shown in FIG. 2, the optical sensor 10 includes a casing module 11, an irradiation module 21, and a light receiving module 41. The casing module 11 includes a housing 12 and an optical window 13. The housing 12 is formed in a hollow box shape and is mainly made of a light-shielding member such as metal or synthetic resin. The irradiation module 21 and the light receiving module 41 are accommodated in an interior of the housing 12. The optical window 13, which is formed in a plate shape from a transparent member such as glass or synthetic resin, for example, is held in the housing 12.

The irradiation module 21 includes a light emitting unit 22 and an irradiation optical system 28. As shown in FIGS. 2 and 5, the light emitting unit 22 includes multiple light emitting sources 23 each provides irradiation light to the sensing area As by emitting light in an infrared range. The light emitting sources 23 are arranged in the vertical direction. Each light emitting source 23 is mainly formed of at least one element such as a laser diode or a light emitting diode. Each light emitting source 23 emits light under control of the control device 1.

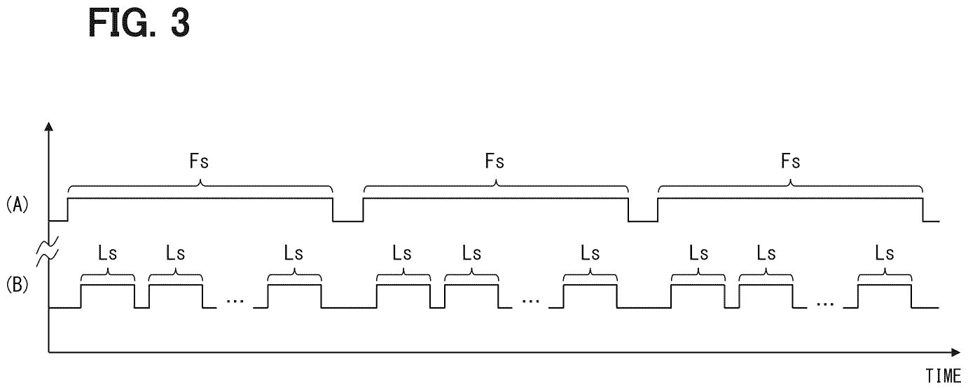

The irradiation optical system 28 shown in FIG. 2 includes an optical element such as a micro lens row or a diffractive optical element. The irradiation optical system 28 exerts an angular dispersion effect for imparting a unique irradiation direction to the irradiation light emitted by each light emitting source 23 in the light emitting unit 22. The irradiation light emitted from the irradiation optical system 28 through the optical window 13 by the sequential light emission of the light emitting sources 23 in the light emitting unit 22 temporally and spatially scans the sensing area As. At this time, particularly in the present embodiment, the light emission of each light emitting source 23 that provides linear irradiation light along the horizontal direction is switched sequentially in the vertical direction for each scanning line Ls of each scanning frame Fs shown in FIG. 3. A time transition graph of FIG. 3(A) shows a control signal of the control device 1 that controls the scanning frame Fs, and a time transition graph of FIG. 3(B) shows a control signal of the control device 1 that controls the scanning line Ls.

Outside the optical sensor 10, a direction in which a scanning range scanned by the irradiation light in the sensing area As changes in response to the sequential light emission from the light emitting sources 23 in the light emitting unit 22 is substantially limited to the vertical direction as a scanning direction α as shown in FIG. 2. In response to such scanning, the reflected light incident from the sensing area As through the optical window 13 is guided to the light receiving module 41.

The light receiving module 41 is disposed to be shifted in the vertical direction with respect to the irradiation module 21. The light receiving module 41 includes a light receiving optical system 42 and a light receiving unit 45. The light receiving optical system 42 includes an optical element such as a lens system of a single lens or a combination thereof, or a micro lens row. The light receiving optical system 42 exerts a condensing action toward the light receiving unit 45 with respect to the reflected light incident through the optical window 13.

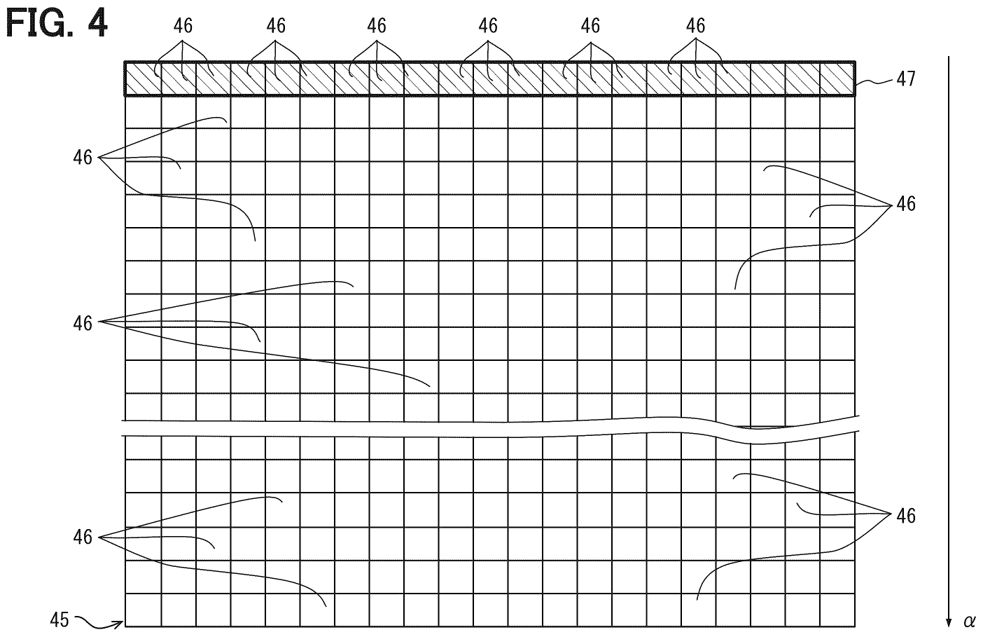

As shown in FIG. 4, the light receiving unit 45 includes multiple light receiving elements 46 that receive reflected light with respect to irradiation light emitted by the light emitting unit 22. In particular, the light receiving elements 46 according to the present embodiment are arranged in a two-dimensional row in the vertical direction or a corresponding inclination direction, and in the horizontal direction. Each light receiving element 46 mainly includes a photosensitive element such as a single photon avalanche diode (SPAD).

As shown in FIG. 2, the reflected light incident from the sensing area As through the optical window 13 and collected by the light receiving optical system 42 is received by the light receiving unit 45. At this time, particularly in the present embodiment, as shown in FIG. 4 with diagonal hatching slanting from top to the right, a row 47 of the light receiving elements 46 (hereinafter, referred to as a light receiving element row) that receives linear reflected light along the horizontal direction according to the irradiation light is switched for each scanning line Ls (see FIG. 3 described above) for each scanning frame Fs in the scanning direction α which is a vertical direction or a corresponding inclination direction on the light receiving unit 45 inside the optical sensor 10. Therefore, in the light receiving element row 47 which is switched for each scanning line Ls, a waveform signal corresponding to the reception of the reflected light is output from the light receiving elements 46.

As shown in FIGS. 2 and 5, the light receiving unit 45 has an output circuit 48 that processes a pulse signal from each light receiving element 46. The output circuit 48 executes read processing of reading light receiving data Dr under the control of the control device 1 for each scanning line Ls of each scanning frame Fs. At this time, particularly in the read processing of the present embodiment, the light receiving data Dr for each scanning line Ls is constructed by sampling and synthesizing a waveform signal from the light receiving element 46 in response to the reception of the reflected light in the light receiving element row 47 switched for each scanning line Ls. The output circuit 48 outputs the light receiving data Dr constructed by the read processing to the control device 1.

The control device 1 shown in FIGS. 1, 2, and 5 controls the light emitting sources 23 of the light emitting unit 22 and the output circuit 48 of the light receiving unit 45 to generate the sensing data Ds based on the light receiving data Dr output from the output circuit 48 for each scanning line Ls of each scanning frame Fs. For this purpose, the control device 1 is mainly formed of at least one dedicated computer, and is connected to the light emitting unit 22 and the light receiving unit 45 via at least one of, for example, a local area network (LAN), a wire harness, and an internal bus. The entirety of the control device 1 may be accommodated inside the housing 12 (example of FIG. 1). The entirety of the control device 1 may be disposed in the vehicle 5 outside the housing 12. The control device 1 may be disposed in a distributed manner across the inside of the housing 12 and the vehicle 5 outside.

The dedicated computer constituting the control device 1 may be a sensor electronic control unit (ECU) specialized for controlling the optical sensor 10. The dedicated computer constituting the control device 1 may be a driving control electronic control unit (ECU) that controls driving of the vehicle 5. The dedicated computer constituting the control device 1 may be a navigation ECU that navigates a travel path of the vehicle 5. The dedicated computer constituting the control device 1 may be a locator ECU that estimates a self-state amount of the vehicle 5.

As shown in FIG. 1, the dedicated computer constituting the control device 1 includes at least one memory 1a and at least one processor 1b. The memory 1a is at least one type of non-transitory tangible storage medium of, for example, a semiconductor memory, a magnetic medium, and an optical medium, for non-transitory storage of computer readable programs, data, and the like. The processor 1b includes, for example, at least one type of a central processing unit (CPU), a graphics processing unit (GPU), a reduced instruction set computer (RISC)-CPU, a data flow processor (DFP), and a graph streaming processor (GSP) as a core.

The processor 1b executes multiple commands included in a control program stored in the memory 1a. Accordingly, the control device 1 controls the optical sensor 10 that receives the reflected light with respect to the irradiation light for each scanning line Ls switched in the scanning direction α in the scanning frame Fs, and constructs multiple functional blocks for outputting the sensing data Ds. As described above, in the control device 1, the control program stored in the memory 1a causes the processor 1b to execute multiple commands, thereby constructing multiple functional blocks. The multiple functional blocks constructed by the control device 1 include a region control block 100 and an output control block 110 as shown in FIG. 5.

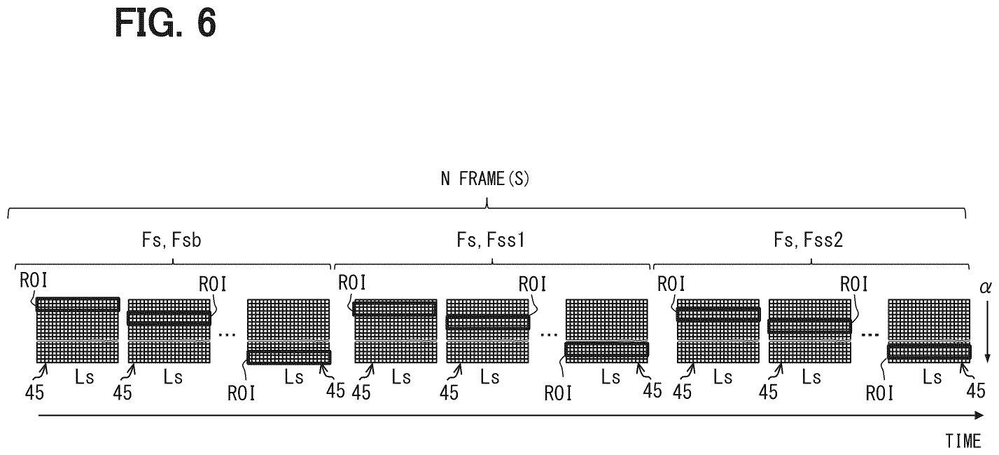

The region control block 100 controls the output circuit 48 of the light receiving unit 45 to set a region of interest (ROI) for each scanning line Ls for each scanning frame Fs. As shown with thick frames in FIGS. 6 to 9, the region of interest ROI is defined as a region in which multiple rows of the light receiving element rows 47, from which the light receiving data Dr is to be read for each scanning line Ls in each scanning frame Fs, are arranged in the scanning direction α. Here, when N is an integer equal to or greater than 2, the number of rows of the light receiving element rows 47 in the region of interest ROI is set to N rows so that the total number of rows of the light receiving element rows 47 in the scanning direction α is a multiple of N or a sum value of a multiple of N and a number of (N−1) or less. Particularly in the region of interest ROI of the present embodiment, the number of rows of the light receiving element rows 47 is controlled to three (N=3).

In the region control block 100, the region of interest ROI for each scanning line Ls is shifted by (N−1) or fewer rows of the light receiving element rows 47 between two successive scanning frames Fs. Here, an integration unit with which the region of interest ROI for each scanning line Ls is integrated by the output control block 110, as described later in detail, by multiple scanning frames Fs shifted forward and backward, is set to N frames, which corresponds to the number of rows N of the light receiving element rows 47 in the region of interest ROI as shown in FIGS. 6 to 9. From the viewpoint of time, the integration unit of the scanning frame Fs is defined as N frames from the current scanning frame Fs to at least one scanning frame Fs corresponding to the previous (N−1) frames.

As the scanning frames Fs of N frames that are the integration unit, particularly in the present embodiment where N=3, one reference frame Fsb and two shift frames Fss1 and Fss2 are defined. Here, in the region control block 100, with reference to the region of interest ROI in the reference frame Fsb, the number of shift rows for shifting the light receiving element rows 47 in the region of interest ROI in each of the shift frames Fss1 and Fss2 is controlled to be (N−1) rows or less.

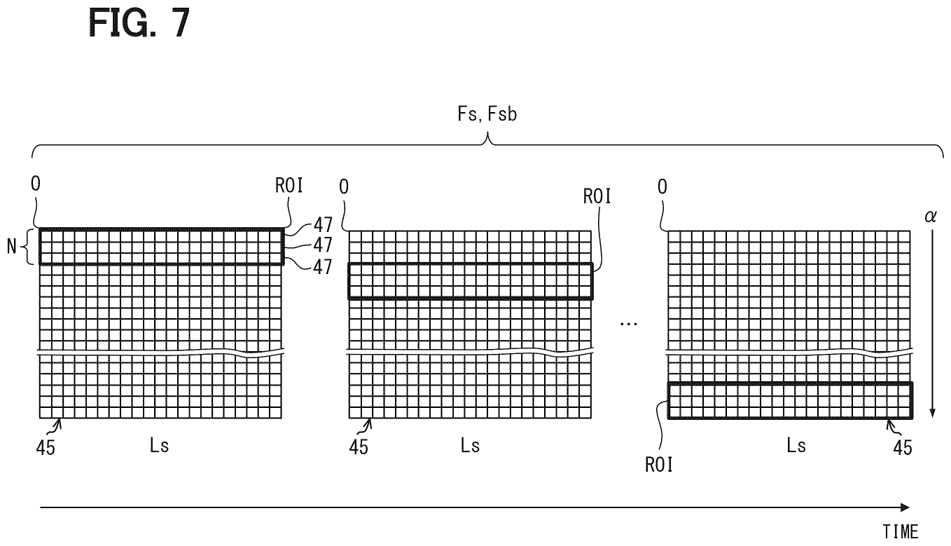

Specifically, as shown in FIGS. 6 and 7, in the reference frame Fsb, the first region of interest ROI corresponding to the first scanning line Ls is controlled for N rows of the light receiving element rows 47 starting from the first light receiving element row 47 with respect to a reference point O in the scanning direction α. Accordingly, in the reference frame Fsb, the second and subsequent regions of interest ROI corresponding to the subsequent scanning lines Ls are sequentially controlled to be shifted from the region of interest ROI of the previous ordinal number by N rows of the light receiving element rows 47 in the scanning direction α, and thus are mutually non-overlapping. Accordingly, the region of interest ROI of each ordinal number in the reference frame Fsb is controlled to a reference position for shifting the region of interest ROI of each ordinal number in the shift frames Fss1 and Fss2, as will be described later.

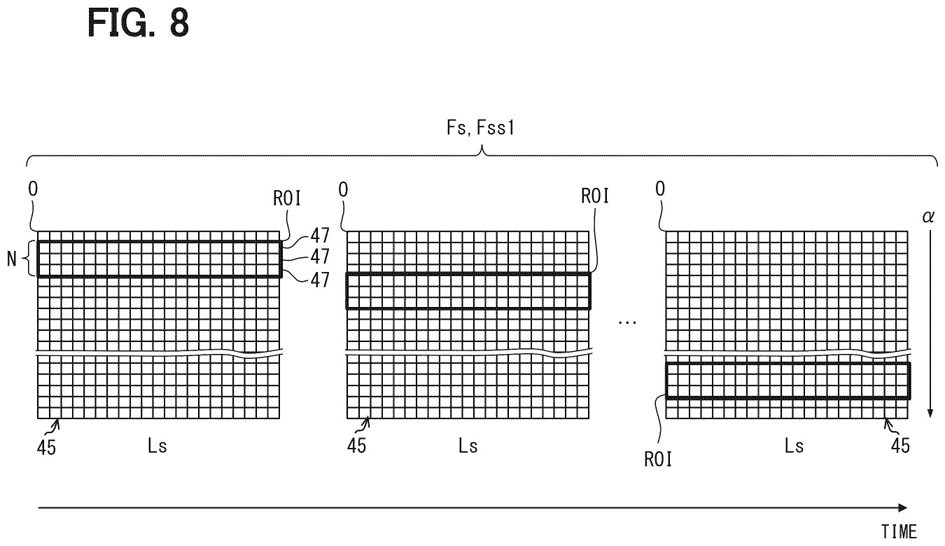

As shown in FIGS. 6 and 8, in the shift frame Fss1 subsequent to the reference frame Fsb, the first region of interest ROI corresponding to the first scanning line Ls is controlled for N rows of the light receiving element rows 47 starting from the second light receiving element row 47 with respect to the reference point O in the scanning direction α. Accordingly, in the shift frame Fss1, the second and subsequent regions of interest ROI corresponding to the subsequent scanning lines Ls are sequentially controlled to be shifted from the region of interest ROI of the previous ordinal number by N rows of the light receiving element rows 47 in the scanning direction α, and thus are mutually non-overlapping. Accordingly, the region of interest ROI of each ordinal number in the shift frame Fss1 is controlled to a position shifted in the scanning direction α by one row of the light receiving element row 47, which is (N−1) or less, with respect to the reference point O and the reference position of the region of interest ROI of the same ordinal number in the previous reference frame Fsb (see FIGS. 6 and 7).

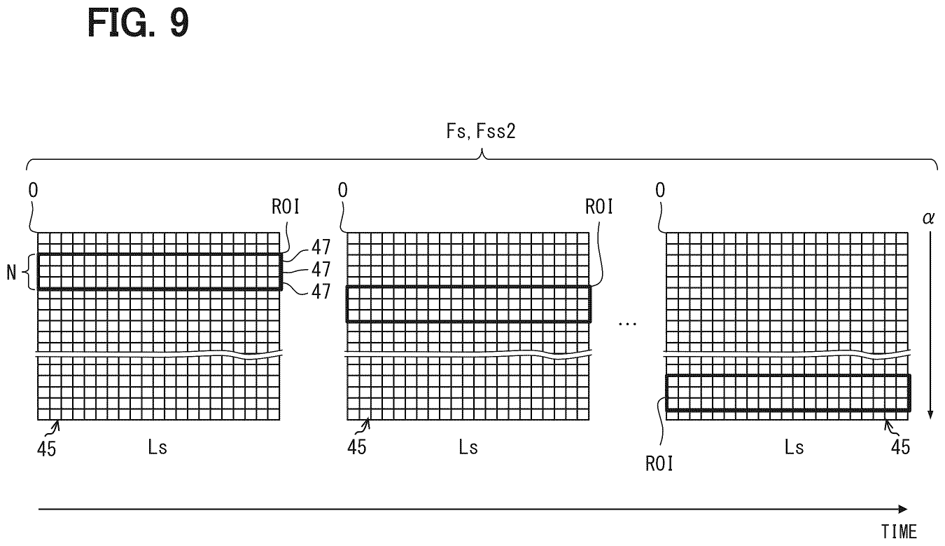

As shown in FIGS. 6 and 9, in the shift frame Fss2 subsequent to the previous shift frame Fss1, the first region of interest ROI corresponding to the first scanning line Ls is controlled for N rows of the light receiving element rows 47 starting from the third light receiving element rows 47 with respect to the reference point O in the scanning direction α. Accordingly, in the shift frame Fss2, the second and subsequent regions of interest ROI corresponding to the subsequent scanning lines Ls are sequentially controlled to be shifted from the region of interest ROI of the previous ordinal number by N rows of the light receiving element rows 47 in the scanning direction α, and thus are mutually non-overlapping. Accordingly, the region of interest ROI of each ordinal number in the shift frame Fss2 is controlled to a position shifted in the scanning direction α by one row of the light receiving element row 47, which is (N−1) or less, with respect to the shift position of the region of interest ROI of the same ordinal number in the previous shift frame Fss1 (see FIGS. 6 and 8).

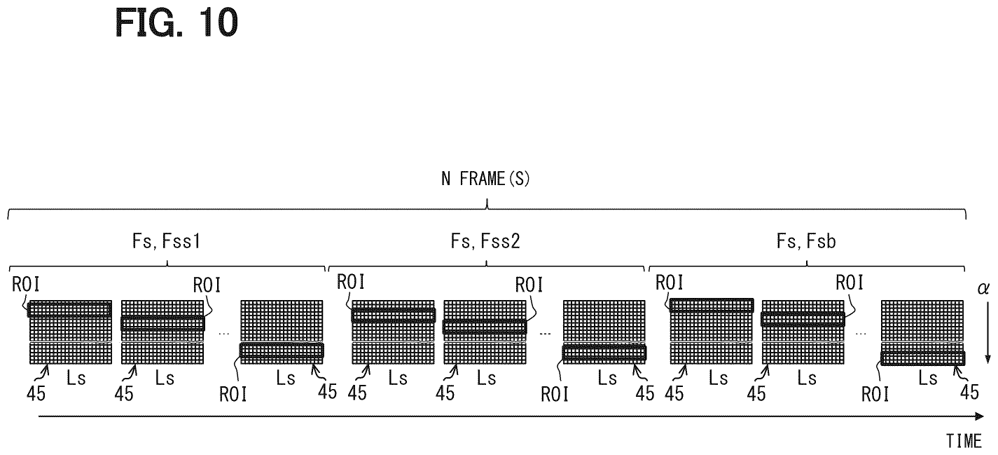

At this time, it can be said that the region of interest ROI of each ordinal number in the shift frame Fss2 in FIGS. 6 and 9 is shifted in the scanning direction α by two rows of the light receiving element rows 47 with respect to the reference point O and the reference position of the region of interest ROI of the same ordinal number in the reference frame Fsb two frames before (see FIGS. 6 and 7). The shift frame Fss2 after the shift is followed by a new reference frame Fsb as the next scanning frame Fs, as shown in FIG. 10. The region of interest ROI of each ordinal number in the new reference frame Fsb is shifted in a reverse direction in the scanning direction α by two rows of the light receiving element rows 47 with respect to the shift position of the region of interest ROI of the same ordinal number in the previous shift frame Fss2.

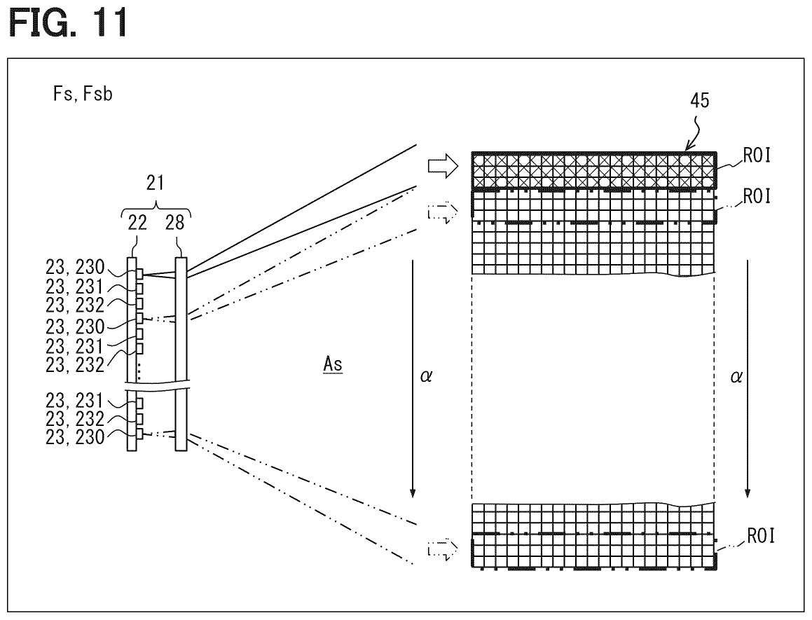

As shown in FIG. 5, the region control block 100 generates a light emitting control signal Cs for each scanning line Ls of each scanning frame Fs in order to control sequential light emission of each light emitting source 23 in the light emitting unit 22 in synchronization with control of the region of interest ROI. At this time, as shown in FIGS. 11 to 13, the light emitting sources 23 to be the light emitting targets are arranged in the vertical direction corresponding to the scanning direction α, with multiple light emitting positions for each scanning frame Fs being aligned to avoid overlapping. In particular, in the vertical direction according to the present embodiment, a light emitting source 230 of the light emitting target in the reference frame Fsb, a light emitting source 231 of the light emitting target in the shift frame Fss1, and a light emitting source 232 of the light emitting target in the shift frame Fss2 are arranged in this order, repeating a pattern of being arranged one by one.

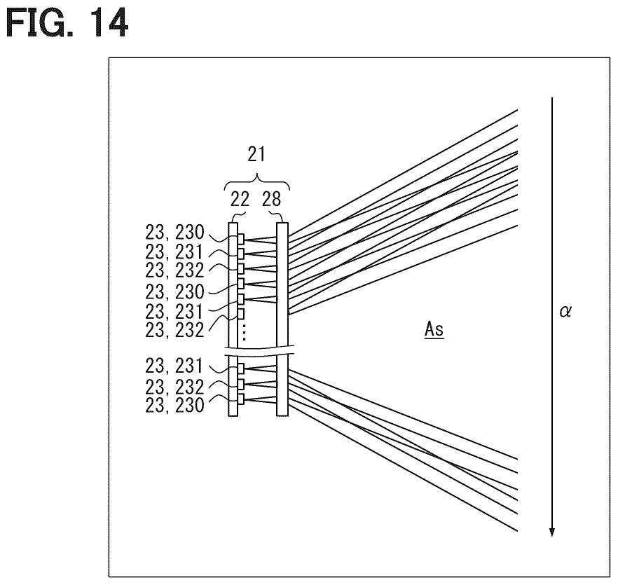

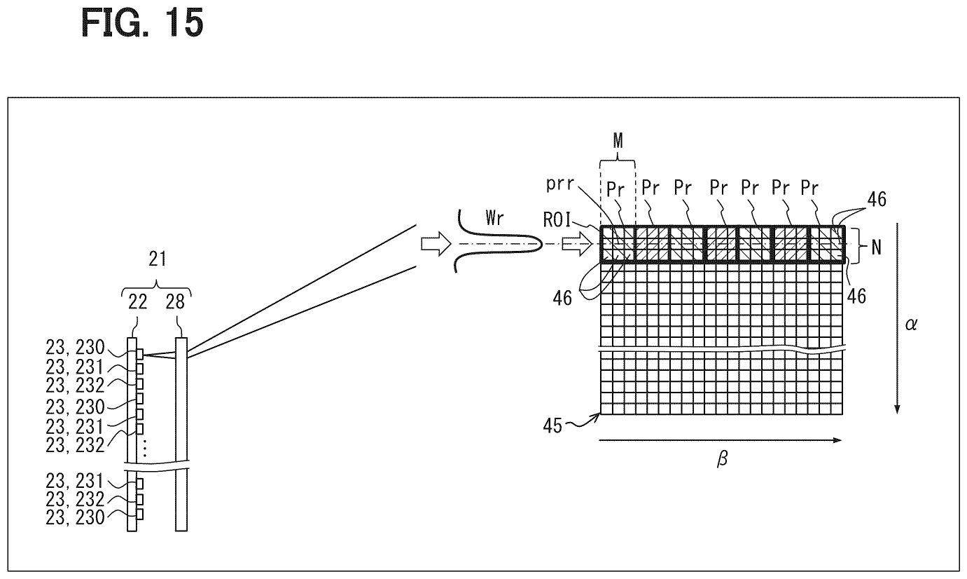

Irradiation directions of the irradiation light emitted by the light emitting sources 230, 231, and 232 sequentially are set to different azimuths by passing through the irradiation optical system 28, as shown in FIG. 14. Accordingly, between the light emitting sources 230 and 231, between the light emitting sources 231 and 232, and between the light emitting sources 232 and 230, which are arranged in the vertical direction, footprints of the irradiation light due to the sequential emission overlap in the sensing area As. As shown in FIG. 15, a configuration for receiving reflected light with a waveform Wr substantially uniformly spreading to both sides in the scanning direction α from a peak aligned with a representative position prr of light receiving pixels Pr to be described in detail later is constructed in each of the light emitting sources 230, 231, and 232 and the irradiation optical system 28.

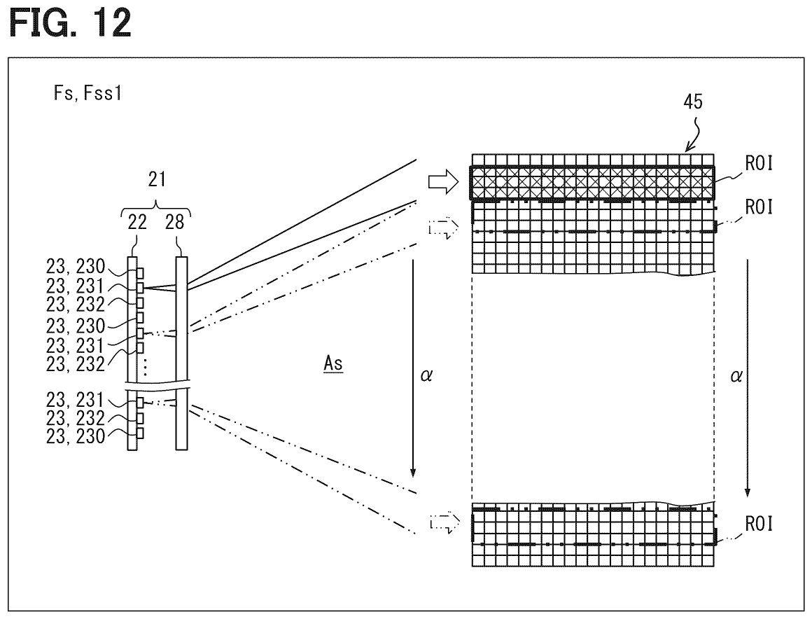

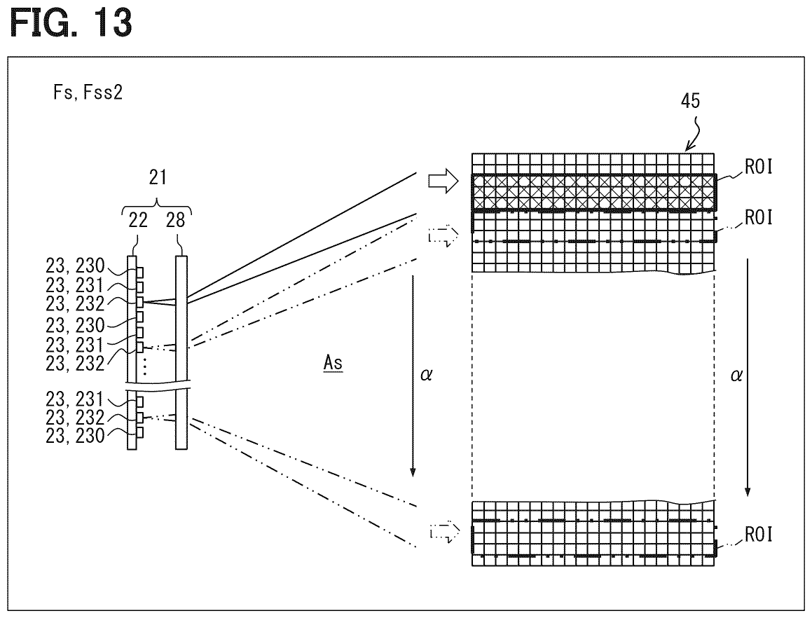

From the configuration of the light emitting unit 22, as shown in FIG. 11, the reflected light is guided to the region of interest ROI of each ordinal number which is sequentially shifted for each scanning line Ls in the reference frame Fsb, in response to the irradiation light emitted by each individual light emitting source 230 according to the light emitting control signal Cs. As shown in FIG. 12, the reflected light is guided to the region of interest ROI of each ordinal number which is sequentially shifted for each scanning line Ls in the shift frame Fss1, in response to the irradiation light sequentially emitted by each individual light emitting source 231. As shown in FIG. 13, the reflected light is guided to the region of interest ROI of each ordinal number which is sequentially shifted for each scanning line Ls in the shift frame Fss2, in response to the irradiation light sequentially emitted by each individual light emitting source 232. In any of the frames Fsb, Fss1, and Fss2, in the region of interest ROI of each ordinal number, the reflected light is received by all of the N rows of the light receiving element rows 47, as shown by cross-hatching in FIGS. 11 to 13. In response to the light reception, the light receiving data Dr is read from the region of interest ROI by the output control block 110 as described in detail later.

As shown in FIG. 5, the output control block 110 controls the output circuit 48 of the light receiving unit 45 so that the set number of light receiving elements 46 for each light receiving element row 47 in the region of interest ROI constitute the light receiving pixel Pr. As shown in FIG. 15 with diagonal hatching slanting from top to the left, the light receiving pixel Pr is defined as a read unit in which the light receiving data Dr are read out in order in a read direction β along the horizontal direction perpendicular to the scanning direction α. Multiple light receiving pixels Pr are defined to be arranged in the read direction β in the region of interest ROI. Here, when M is an integer equal to or greater than 2, the number of the light receiving elements 46 arranged in the read direction β in the light receiving pixel Pr is set to M so that a total number of alignments of the light receiving elements 46 in the read direction β is a multiple of M or a sum value of a multiple of M and a number of (M−1) or less. In particular, in the region of interest ROI according to the present embodiment, the set number of the light receiving elements 46 for each light receiving element row 47 is controlled to be the same as the number of rows N of the light receiving element rows 47, that is, three (M=N=3), the same as the number of the light receiving elements 46 arranged in the scanning direction α.

As shown in FIG. 5, the output control block 110 generates the sensing data Ds by integrating the light receiving data Dr read from the region of interest ROI for each scanning line Ls for each scanning frame Fs of the integration unit. At this time, reading of the light receiving data Dr from the region of interest ROI is performed in units of light receiving pixels Pr in the same region ROI. Therefore, by defining the representative position prr at the center of the light receiving pixels Pr in each of the directions α and β as shown in FIG. 15, the light receiving data Dr read from the light receiving pixel Pr is associated with the representative position prr. Accordingly, the light receiving data Dr at the representative position prr read in units of the light receiving pixels Pr from the region of interest ROI for each scanning frame Fs of the integration unit are integrated with each other to become the sensing data Ds such as image data.

Here, the representative positions prr of the light receiving pixels Pr in each region of interest ROI in the reference frame Fsb, each region of interest ROI in the shift frame Fss1, and each region of interest ROI in the shift frame Fss2 do not overlap each other due to shift processing in the region control block 100. As a result, the integration of the light receiving data Dr read in the units of the light receiving pixels Pr from each region of interest ROI in the reference frame Fsb, each region of interest ROI in the shift frame Fss1, and each region of interest ROI in the shift frame Fss2 generates the sensing data Ds with high resolution with an increased number of pixels.

In the output control block 110, suitably, the light receiving data Dr read in the units of the light receiving pixels Pr from the region of interest ROI for each scanning frame Fs of the integration unit may be integrated after the representative position prr (see FIG. 15 described above) that is the sensing position is compensated according to a traveling speed of the vehicle 5. At this time, when the traveling speed of the vehicle 5 exceeds a zero speed or exceeds a slow speed that can be regarded as the zero speed, the representative position prr associated with the light receiving data Dr read in the units of the light receiving pixels Pr is compensated so as to be aligned by correcting a shift in the sensing position due to the traveling speed. Particularly in the present embodiment, among all the scanning frames Fs of the integration unit, compensation of the representative position prr is performed on the light receiving data Dr read in the two subsequent scanning frames Fs, which are shifted in time from the first scanning frame Fs.

For the alignment for compensating for the representative position prr, for example, an algorithm such as an iterative closest point (ICP) may be used. The traveling speed used for the alignment for compensating for the representative position prr may be acquired based on at least one of detection speed information detected by a sensor of the vehicle 5 and movement amount information on a point cloud position (corresponding to the representative position prr in the present embodiment) between the light receiving data Dr. For the alignment for compensating for the representative position prr, various different kinds of motion information of the vehicle 5, such as steering information, in addition to the traveling speed, may be used.

When the traveling speed of the vehicle 5 is equal to or lower than the zero speed or the slow speed, the output control block 110 integrates the light receiving data Dr read in units of the light receiving pixels Pr from the region of interest ROI for each scanning frame Fs of the integration unit without compensating for the sensing position. Accordingly, it is possible to reduce power consumption required for alignment processing to compensate for the sensing position when the vehicle 5 is in a traveling stop state, for example, when the vehicle 5 is started.

As shown in FIG. 5, the output control block 110 outputs the generated sensing data Ds. At this time, the sensing data Ds may be output to another control device, such as an ECU, which is different from the dedicated computer constituting the control device 1, and may be utilized for control in the other control device. The sensing data Ds may be stored as an output to the memory 1a disposed inside (the example of FIG. 5) or outside the optical sensor 10, and may be utilized at appropriate time.

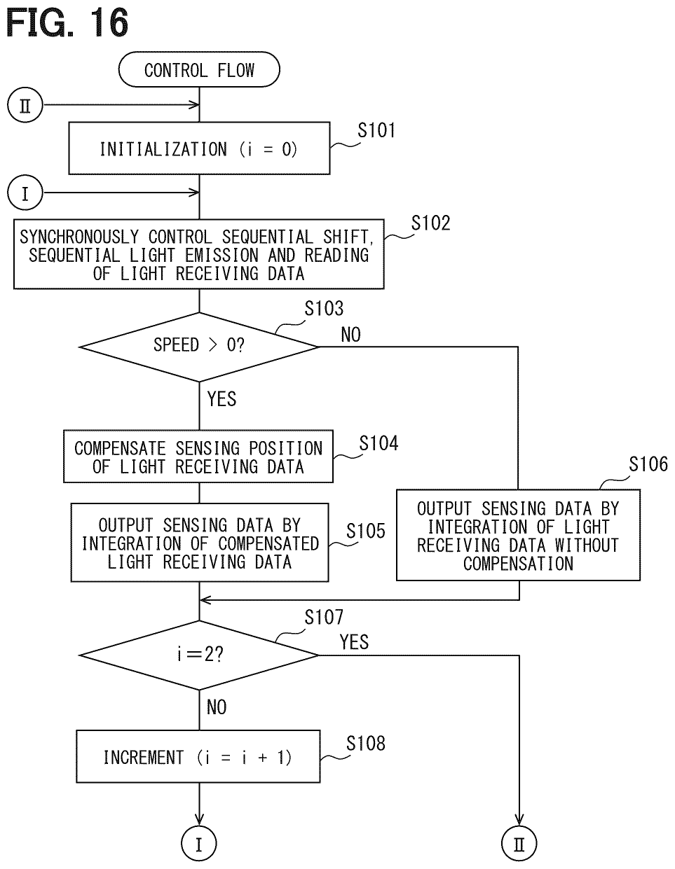

By the cooperation of the blocks 100 and 110, a control method in which the control device 1 controls the optical sensor 10 is executed according to a control flow shown in FIG. 16. This control flow is started in response to the start of the vehicle 5, and ends in response to a complete stop of the vehicle 5. Each “S” in the control flow means multiple steps executed by multiple commands included in a control program.

In S101, the region control block 100 initializes an index i to 0. When i=0, the scanning frame Fs from which the light receiving data Dr is to be read is selected as the reference frame Fsb. On the other hand, when i=1, the scanning frame Fs from which the light receiving data Dr is to be read is selected as the previous shift frame Fss1. When i=2, the scanning frame Fs from which the light receiving data Dr is to be read is selected as the subsequent shift frame Fss2.

In S102, the region control block 100 synchronously controls the sequential shift of the region of interest ROI and the sequential light emission of each light emitting source 23 for each scanning line Ls of the scanning frame Fs corresponding to the index i. At this time, in the reference frame Fsb of i=0, the region control block 100 causes the light emitting sources 230 for the same frame Fsb to sequentially emit light in accordance with the region of interest ROI of each ordinal number, which is sequentially controlled to each reference position. On the other hand, in the shift frame Fss1 of i=1, the region control block 100 causes the light emitting sources 231 for the same frame Fss1 to sequentially emit light in accordance with the region of interest ROI of each ordinal number, which is sequentially controlled to a position shifted by one row of the light receiving element rows 47 from the reference frame Fsb. Further, in the shift frame Fss2 of i=2, the region control block 100 causes the light emitting sources 232 for the same frame Fss2 to sequentially emit light in accordance with the region of interest ROI of each ordinal number, which is sequentially controlled to a position shifted by one row of the light receiving element rows 47 from the shift frame Fss1.

In S102, for each scanning line Ls in the scanning frame Fs corresponding to the index i, reading of the light receiving data Dr from the region of interest ROI controlled by the region control block 100 is also synchronously controlled by the output control block 110. At this time, the light receiving data Dr is temporarily stored in a light receiving storage area 1ar (see FIG. 5) of the memory 1a in association with the representative position prr for each light receiving pixel Pr of the region of interest ROI whose position is controlled. In the light receiving storage area 1ar of the memory 1a arranged inside and/or outside the optical sensor 10, a storage capacity capable of temporarily storing and holding the light receiving data Dr is secured for N frames of scanning frames Fs that form the integration unit. As the memory 1a for securing the light receiving storage area 1ar having such a storage capacity, for example, a double data rate synchronous dynamic random access memory (DDRSDRAM) or the like may be adopted.

In subsequent S103, the output control block 110 determines whether a current traveling speed of the vehicle 5 exceeds the zero speed or exceeds the slow speed (the control flow of FIG. 16 is an example in which a determination criterion is exceeding the zero speed). As a result, if an affirmative determination is made, the control flow proceeds to S104.

In S104, the output control block 110 compensates for the sensing positions of the current and previous light receiving data Dr read out for the scanning frames Fs of the current integration unit in S102, with all of the N frames of the scanning frames Fs from the current to previous (N−1) frames being the current integration unit. At this time, for the light receiving data Dr for the frames Fsb, Fss1, and Fss2 of i=0, 1, and 2 constituting the current integration unit, the representative position prr of each light receiving pixel Pr is compensated according to the current traveling speed of the vehicle 5.

In subsequent S105, the output control block 110 integrates the light receiving data Dr for the frames Fsb, Fss1, and Fss2 of i=0, 1, and 2 compensated in the previous S104 as the scanning frames Fs of the current integration unit from the current to previous (N−1) frames. Accordingly, the output control block 110 in S105 generates and outputs the sensing data Ds.

When a negative determination is made in S103 in response to the execution of S104 and S105, the control flow proceeds to S106. In S106, the output control block 110 integrates the current and previous light receiving data Dr read out by S102 for the frames Fsb, Fss1, and Fss2 of i=0, 1, and 2 as the scanning frame Fs of the current integration unit from the current to previous (N−1) frames, without compensating for the sensing position. Accordingly, the output control block 110 in S106 generates and outputs the sensing data Ds.

After completion of both S105 and S106, the control flow proceeds to S107. In S107, the region control block 100 determines whether the index i is 2. As a result, if a negative determination is made, the control flow proceeds to S108, and after the region control block 100 increments the index i by 1 (i=i+1), the control flow returns to S102. On the other hand, if an affirmative determination is made, the control flow returns to S101.

The operation and effects of the first embodiment described above will be described below.

In the first embodiment, the light receiving data Dr is read from the region of interest ROI for each scanning line Ls for each scanning frame Fs in which the scanning line Ls is switched in the scanning direction α. When an integer N equal to or greater than 2 is defined, in the optical sensor 10, the region of interest ROI in which N rows of the light receiving element rows 47 are arranged in the scanning direction α and the light receiving data Dr is read out for each scanning line Ls is shifted by (N−1) or fewer rows of the light receiving element rows 47 between the successive scanning frames Fs. According to this, a scanning time required to read the light receiving data Dr while shifting the region of interest ROI for each scanning line Ls is a time for each scanning frame Fs, and thus can be shortened as much as possible.

Further, according to the first embodiment, the light receiving data Dr read out from the region of interest ROI for each scanning line Ls for each scanning frame Fs is integrated by the scanning frames Fs from the current to previous (N−1) frames, and is output as the sensing data Ds. According to this, in the sensing data Ds output by the integration of the light receiving data Dr read from the region of interest ROI for each scanning line Ls for each scanning frame Fs, resolution can be increased according to the shift of the region of interest ROI between the successive scanning frames Fs.

In the first embodiment as described above, it is possible to satisfy both an increase in a frame rate by shortening the scanning time for each scanning frame Fs and an increase in resolution by increasing the resolution of the output sensing data Ds. Therefore, it is possible to increase the sensing accuracy.

According to the first embodiment, the light receiving data Dr read from the region of interest ROI for each scanning line Ls for each scanning frame Fs is integrated after the sensing position is compensated for according to the traveling speed of the vehicle 5 on which the optical sensor 10 is mounted. According to this, the light receiving data Dr read from the region of interest ROI for each scanning line Ls for each scanning frame Fs can be integrated after reducing the shift in the sensing position, which is a concern as the traveling speed increases. Therefore, it is possible to secure reliability of the sensing data Ds with high resolution compatible with a high frame rate, and to improve the sensing accuracy.

According to the first embodiment, in the region of interest ROI, a set number of light receiving elements 46 for each light receiving element row 47 constitute a light receiving pixel Pr which is a read unit of the light receiving data Dr. Therefore, in the sensing data Ds obtained by integrating the light receiving data Dr read from the light receiving pixels Pr in the region of interest ROI for each scanning line Ls for each scanning frame Fs, the resolution can be further increased by increasing the number of pixels according to the shift of the region of interest ROI. Therefore, it is possible to secure high resolution compatible with a high frame rate and to improve the sensing accuracy.

In each scanning frame Fs according to the first embodiment, the light receiving data Dr read in response to the light reception by all of the N rows of the light receiving element rows 47 is integrated for each scanning line Ls. According to this, the light receiving data Dr read from the region of interest ROI for each scanning line Ls for each scanning frame Fs can be integrated after being generated with a high SN ratio by using all rows of the light receiving element rows 47 in the same region ROI. Therefore, in addition to high resolution compatible with a high frame rate, the output of the sensing data Ds makes it possible to improve the sensing accuracy.

### Second Embodiment

A second embodiment is a modification of the first embodiment.

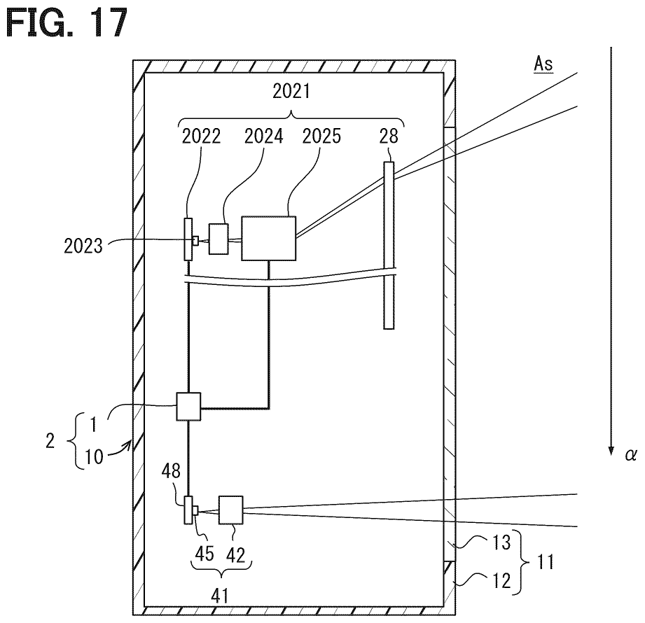

As shown in FIG. 17, an irradiation module 2021 according to the second embodiment includes, in addition to the irradiation optical system 28 similar to that of the first embodiment, a light emitting unit 2022 having a single light emitting source 2023, a collimator 2024, and a scanning unit 2025.

Specifically, the collimator 2024 mainly includes a collimating lens that exerts a collimate effect on the irradiation light emitted by the single light emitting source 2023. The collimator 2024 linearly collimates the irradiation light along the horizontal direction. The scanning unit 2025 mainly includes a scanning mechanism including a reflection mirror such as a single-surface mirror or a polygon mirror that gives a variable irradiation direction to the irradiation light collimated by the collimator 2024. Under the control of the control device 1, the scanning unit 2025 variably adjusts a projection point of the irradiation light with respect to the irradiation optical system 28 in the vertical direction along the scanning direction α.

By variable adjustment of the projection point with respect to the irradiation optical system 28, the irradiation light emitted from the same system 28 through the optical window 13 temporally and spatially scans the sensing area As. At this time, particularly in the present embodiment, the irradiation direction in which the single light emitting source 2023 emits light to emit the irradiation light linearly along the horizontal direction is sequentially switched for each scanning line Ls for each scanning frame Fs. Accordingly, outside the optical sensor 10, the scanning direction α in which the scanning range scanned by the irradiation light in the sensing area As changes is substantially limited to the vertical direction.

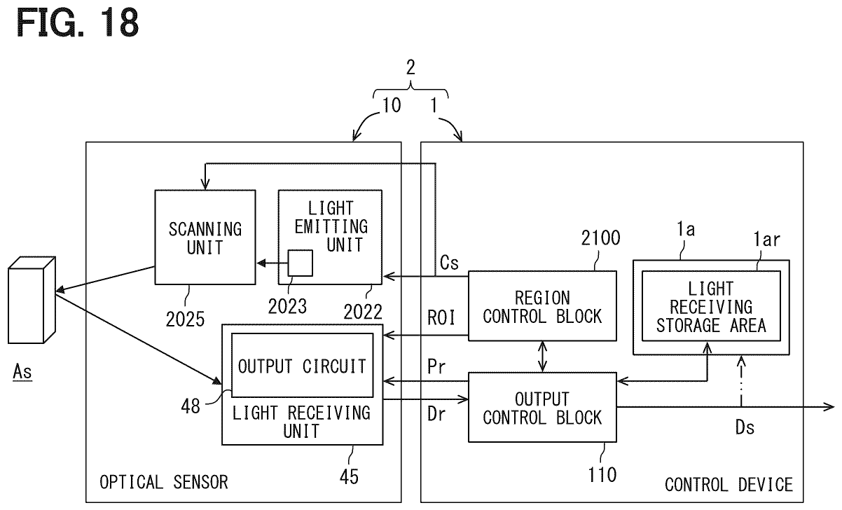

As shown in FIG. 18, a region control block 2100 according to the second embodiment generates the light emitting control signal Cs for each scanning line Ls for each scanning frame Fs in order to control the light emitting unit 2022 and the scanning unit 2025 in synchronization with the control of the region of interest ROI. At this time, the control of the light emitting unit 2022 and the scanning unit 2025 by the light emitting control signal Cs is switching control of the irradiation direction by the scanning unit 2025 with respect to the irradiation light emitted by the light emitting source 2023.

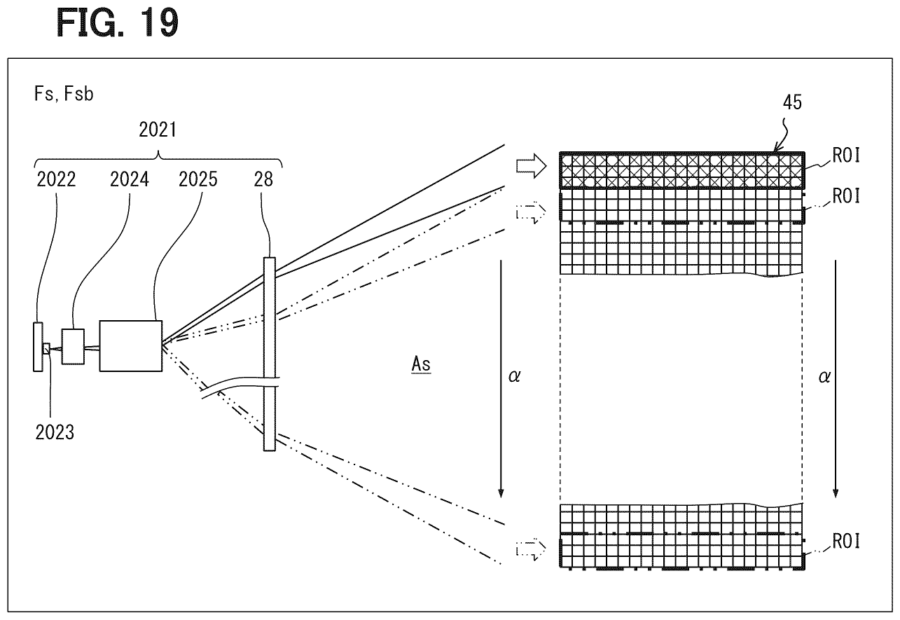

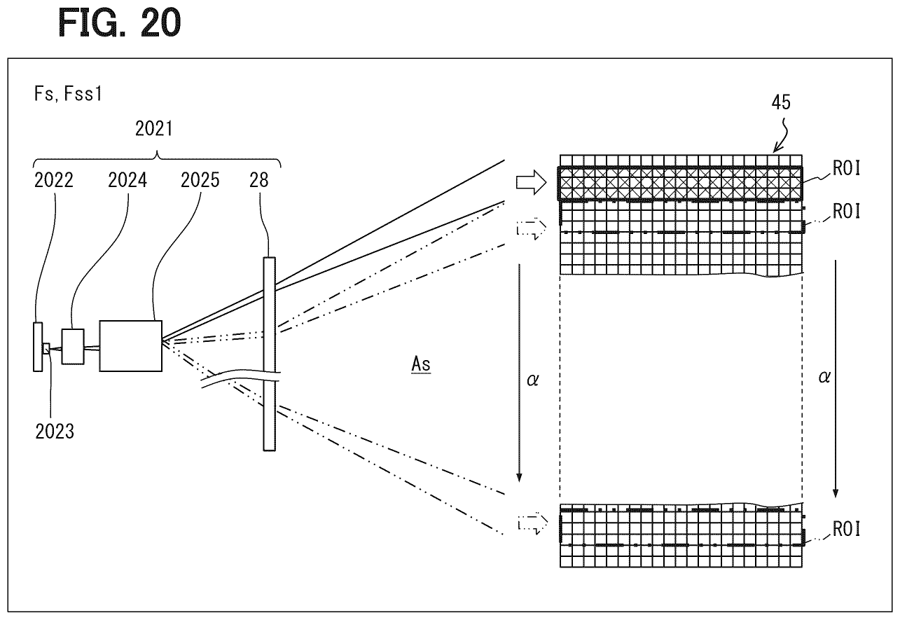

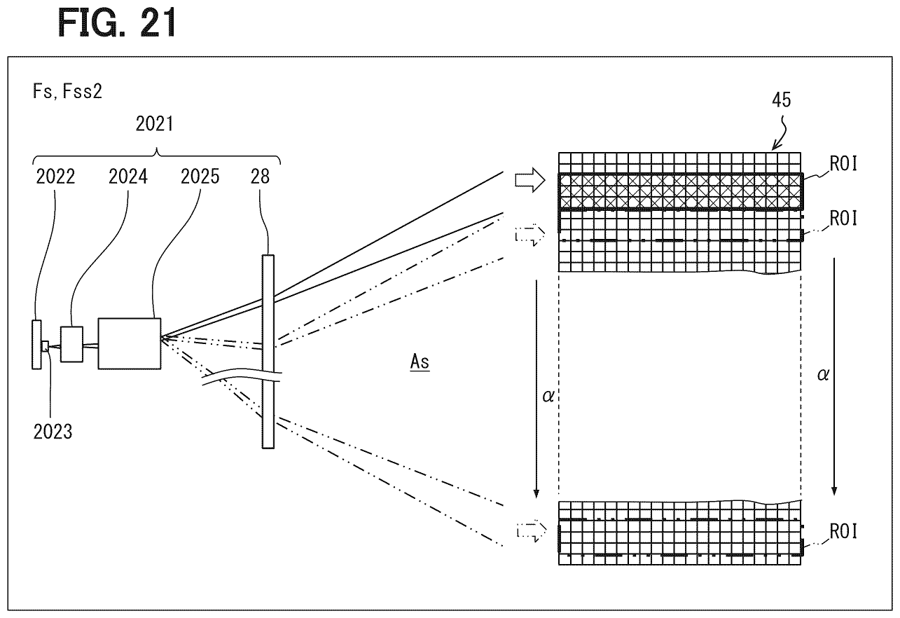

Specifically, reflected light is guided to the region of interest ROI of each ordinal number, which is sequentially shifted for each scanning line Ls in the reference frame Fsb, in response to the irradiation direction of the irradiation light emitted by the light emitting source 2023 being switched by the scanning unit 2025, as shown in FIG. 19. Similarly, the reflected light is guided to the region of interest ROI of each ordinal number, which is sequentially shifted for each scanning line Ls in the shift frame Fss1, in response to the irradiation direction of the irradiation light emitted by the light emitting source 2023 being switched by the scanning unit 2025, as shown in FIG. 20. The reflected light is guided to the region of interest ROI of each ordinal number, which is sequentially shifted for each scanning line Ls in the shift frame Fss2, in response to the irradiation direction of the irradiation light emitted by the light emitting source 2023 being switched by the scanning unit 2025, as shown in FIG. 21. In any of the frames Fsb, Fss1, and Fss2, in each region of interest ROI for each scanning line Ls, as shown by cross-hatching in FIGS. 19 to 21, the reflected light is received by all of the N rows of the light receiving element rows 47.

In the second embodiment, in S102 of the control flow, the region control block 2100 synchronously controls, for each scanning line Ls of the scanning frame Fs corresponding to the index i, the sequential shift of the region of interest ROI, the light emission of the light emitting unit 2022, and the sequential switching of the irradiation direction by the scanning unit 2025. At this time, in the reference frame Fsb of i=0, the region control block 2100 causes the scanning unit 2025 to sequentially switch the irradiation direction of the irradiation light in accordance with the region of interest ROI of each ordinal number, which is sequentially controlled to each reference position. On the other hand, in the shift frame Fss1 of i=1, the region control block 2100 causes the scanning unit 2025 to sequentially switch the irradiation direction of the irradiation light in accordance with the region of interest ROI of each ordinal number, which is sequentially controlled to a position shifted by one row of the light receiving element rows 47 from the reference frame Fsb. Further, in the shift frame Fss2 of i=2, the region control block 2100 causes the scanning unit 2025 to sequentially switch the irradiation direction of the irradiation light in accordance with the region of interest ROI of each ordinal number, which is sequentially controlled to a position shifted by one row of the light receiving element rows 47 from the shift frame Fss1.

In S102 of such a control flow, the reading of the light receiving data Dr in response to the light reception is controlled by the output control block 110 as in the first embodiment. In the second embodiment as described above, the same effects as in the first embodiment can be exerted.

### Third Embodiment

A third embodiment is a modification of the second embodiment.

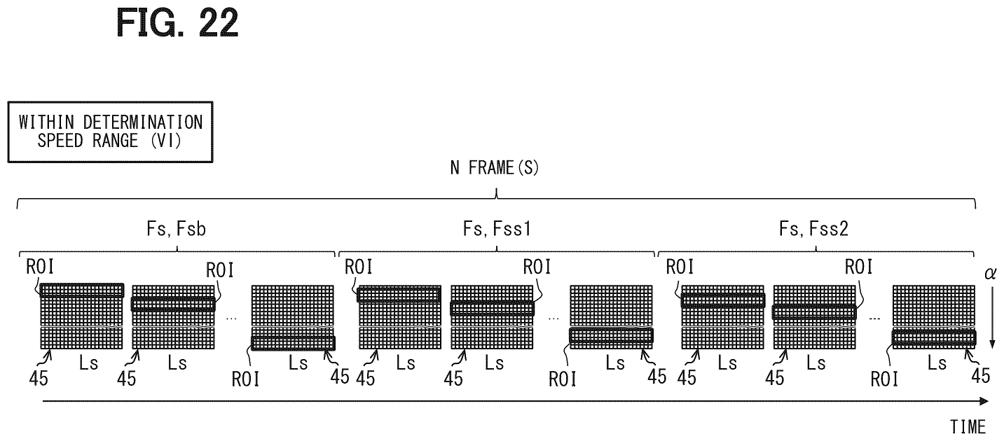

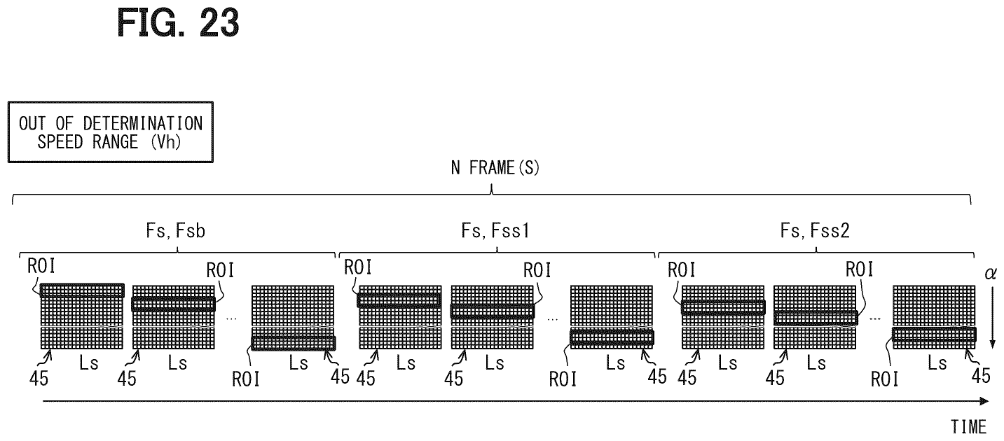

As shown in FIGS. 22 and 23, in the third embodiment, the number of rows of the light receiving element rows 47 to be shifted between the successive scanning frames Fs increases as the traveling speed of the vehicle 5 increases. Specifically, in the reference frame Fsb, as shown in FIGS. 22 to 24, regardless of whether the traveling speed of the vehicle 5 is a low speed side (VI) within a determination speed range or a high speed side (Vh) out of the determination speed, the region of interest ROI of each ordinal number is controlled to the same reference position as in the first embodiment. Here, the determination speed range is defined as a range equal to or less than a threshold speed or less than the threshold speed with a low speed such as a slow speed or 30 km/h as a threshold speed. In the present embodiment, when the traveling speed changes from one to the other out of the determination speed at the timing when either of the shift frames Fss1 and Fss2 is executed as the current scanning frame Fs, a determination result of the traveling speed is assumed to remain the same as the one until the next reference frame Fsb.

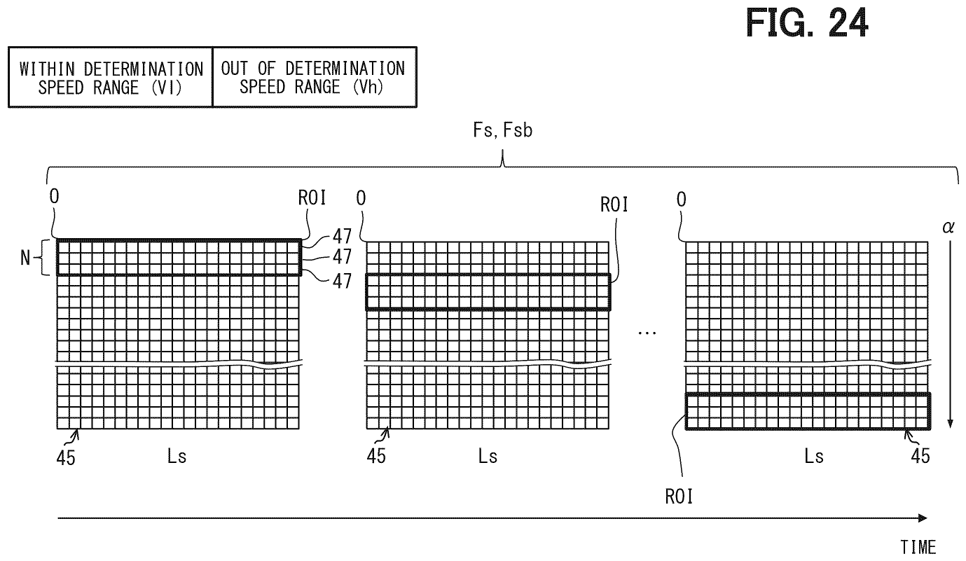

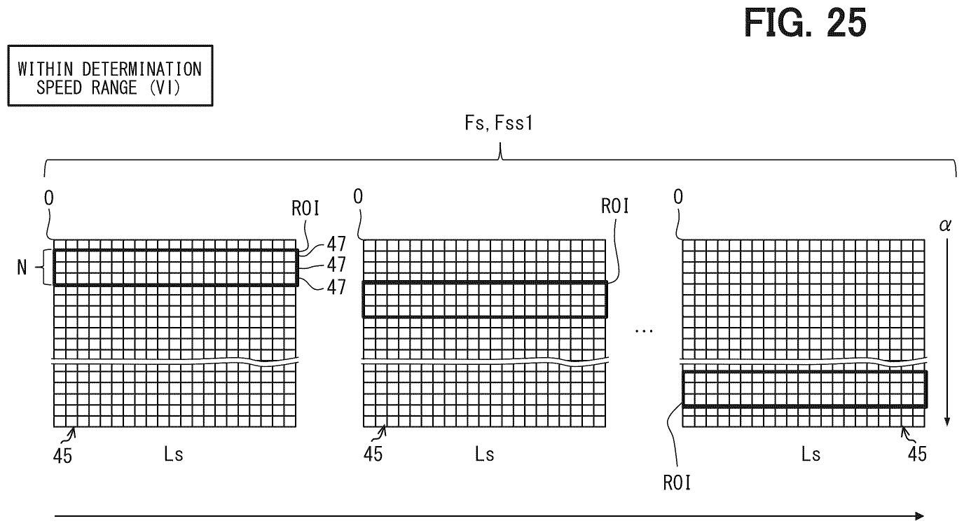

As shown in FIGS. 22 and 25, in the shift frame Fss1 in the case in which the traveling speed of the vehicle 5 is within the determination speed range, the region of interest ROI of each ordinal number is controlled as in the first embodiment. That is, according to the traveling speed within the determination speed range, in the shift frame Fss1, the region of interest ROI of each ordinal number is shifted in the scanning direction α by one row of the light receiving element row 47, which is (N−1) or less, with respect to the reference point O and the region of interest ROI of the same ordinal number in the previous reference frame Fsb (see FIGS. 22 and 24).

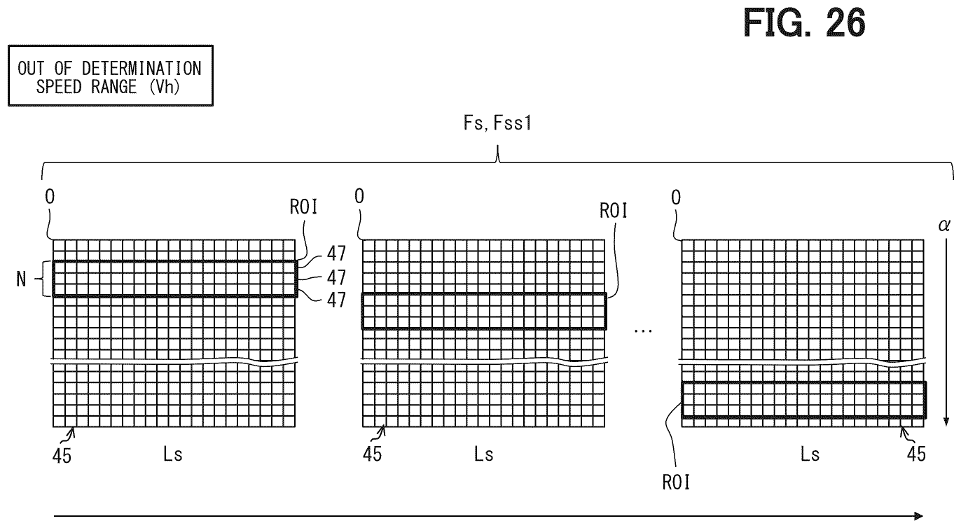

As shown in FIGS. 23 and 26, in the shift frame Fss1 in the case in which the traveling speed of the vehicle 5 is out of the determination speed range, the first region of interest ROI corresponding to the leading scanning line Ls is controlled for N rows of the light receiving element rows 47 starting from the third light receiving element row 47 with respect to the reference point O in the scanning direction α. Accordingly, in the shift frame Fss1 in the case where the traveling speed is out of the determination speed range, the second and subsequent regions of interest ROI corresponding to the subsequent scanning lines Ls are sequentially controlled to be shifted from the region of interest ROI of the previous ordinal number by N rows of the light receiving element rows 47 in the scanning direction α, and thus are mutually non-overlapping. Accordingly, according to the traveling speed that is out of the determination speed range, in the shift frame Fss1, the region of interest ROI of each ordinal number is shifted in the scanning direction α by two rows of the light receiving element row 47, which is (N−1) or less, with respect to the reference point O and the region of interest ROI of the same ordinal number in the previous reference frame Fsb (see FIGS. 23 and 24).

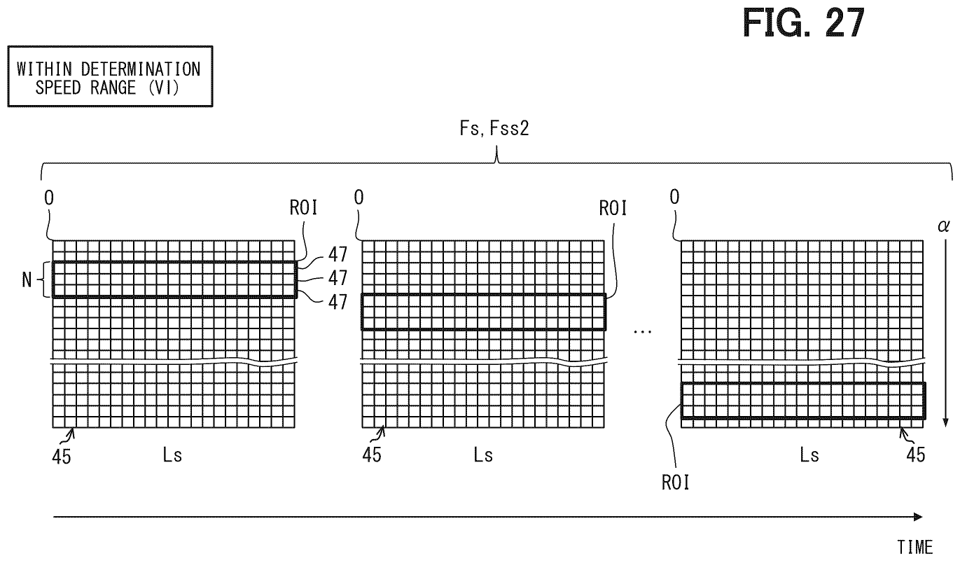

As shown in FIGS. 22 and 27, in the shift frame Fss2 in the case in which the traveling speed of the vehicle 5 is within the determination speed range, the region of interest ROI of each ordinal number is controlled as in the first embodiment. That is, according to the traveling speed within the determination speed range, in the shift frame Fss2, the region of interest ROI of each ordinal number is shifted in the scanning direction α by one row of the light receiving element row 47, which is (N−1) or less, with respect to the region of interest ROI of the same ordinal number in the previous shift frame Fss1 (see FIGS. 22 and 25). At this time, the region of interest ROI of each ordinal number in the shift frame Fss2 is shifted in the scanning direction α by two rows of the light receiving element rows 47 with respect to the reference point O and the region of interest ROI of the same ordinal number in the reference frame Fsb two frames before (see FIGS. 22 and 24). In a new reference frame Fsb subsequent to the shift frame Fss2 after the shift, the region of interest ROI of each ordinal number is shifted in a reverse direction of the scanning direction α by two rows of the light receiving element rows 47 with respect to the region of interest ROI of the same ordinal number in the previous frame Fss2.

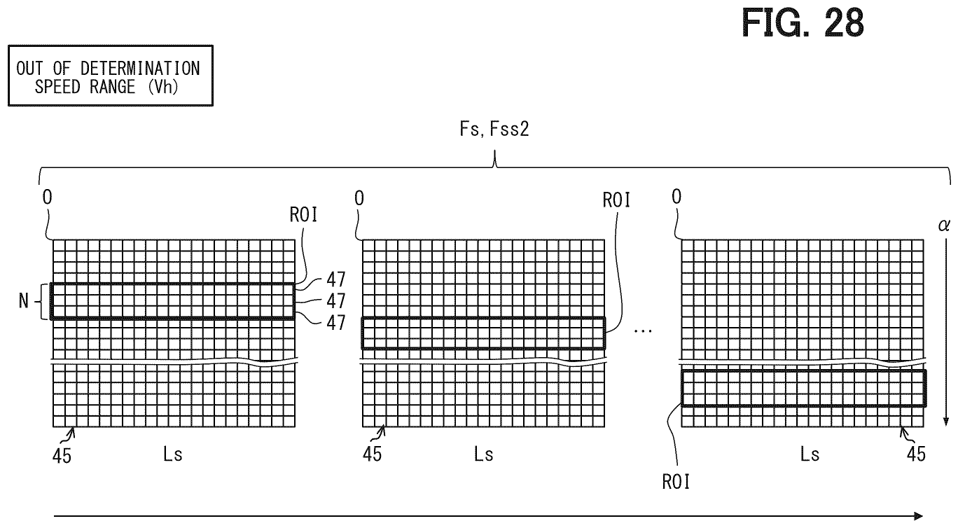

As shown in FIGS. 23 and 28, in the shift frame Fss2 in the case in which the traveling speed of the vehicle 5 is out of the determination speed range, the first region of interest ROI corresponding to the leading scanning line Ls is controlled for N rows of the light receiving element rows 47 starting from the fifth light receiving element row 47 with respect to the reference point O in the scanning direction α. Accordingly, in the shift frame Fss2 in the case where the traveling speed is out of the determination speed range, the second and subsequent regions of interest ROI corresponding to the subsequent scanning lines Ls are sequentially controlled to be shifted from the region of interest ROI of the previous ordinal number by N rows of the light receiving element rows 47, and thus are mutually non-overlapping. Accordingly, according to the traveling speed that is out of the determination speed range, in the shift frame Fss2, the region of interest ROI of each ordinal number is shifted in the scanning direction α by two rows of the light receiving element rows 47, which is (N−1) or less, with respect to the region of interest ROI of the same ordinal number in the previous shift frame Fss1 (see FIGS. 23 and 26).

At this time, in the shift frame Fss2 in FIGS. 23 and 28, according to the traveling speed that is out of the determination speed range, it can be said that the region of interest ROI of each ordinal number is shifted in the scanning direction α by four rows of the light receiving element rows 47 with respect to the reference point O and the region of interest ROI of the same ordinal number in the reference frame Fsb two frames before (see FIGS. 23 and 24). According to such an increase in the number of shift rows, it is possible to reduce memory access and power consumption for temporarily storing the light receiving data Dr at a traveling speed that is out of the determination speed range. In the new reference frame Fsb subsequent to the shift frame Fss2 after the shift, the region of interest ROI of each ordinal number is shifted in the reverse direction of the scanning direction α by four rows of the light receiving element rows 47 with respect to a shift position of the region of interest ROI of the same ordinal number in the previous frame Fss2.

In the third embodiment, in S102 of the control flow, the region control block 2100 synchronously controls, for each scanning line Ls of the scanning frame Fs corresponding to the index i, the sequential shift of the region of interest ROI and the sequential switching of the light emission and the irradiation direction according to the traveling speed of the vehicle 5. At this time, in the reference frame Fsb of i=0 regardless of the traveling speed, the region control block 2100 sequentially switches the irradiation direction in accordance with the region of interest ROI of each ordinal number, which is sequentially controlled to each reference position.

In the shift frame Fss1 of i=1, the region control block 2100 sequentially switches the irradiation direction at the traveling speed within the determination speed range in accordance with the region of interest ROI of each ordinal number, which is sequentially controlled to a position shifted by one row of the light receiving element row 47 from the reference frame Fsb. On the other hand, at the traveling speed that is out of the determination speed range, the region control block 2100 in the shift frame Fss1 sequentially switches the irradiation direction in accordance with the region of interest ROI of each ordinal number, which is sequentially controlled to a position shifted by two rows of the light receiving element rows 47 from the reference frame Fsb.

In the shift frame Fss2 of i=2, the region control block 2100 sequentially switches the irradiation direction at the traveling speed within the determination speed range in accordance with the region of interest ROI of each ordinal number, which is sequentially controlled to a position shifted by one row of the light receiving element row 47 from the shift frame Fss1. On the other hand, at the traveling speed that is out of the determination speed range, the region control block 2100 in the shift frame Fss2 sequentially switches the irradiation direction in accordance with the region of interest ROI of each ordinal number, which is sequentially controlled to a position shifted by two rows of the light receiving element rows 47 from the shift frame Fss1.

According to the third embodiment as described above, the number of rows of the light receiving element rows 47 shifted between the successive scanning frames Fs increases as the traveling speed of the vehicle 5 on which the optical sensor 10 is mounted increases. According to this, the light receiving data Dr read from the region of interest ROI for each scanning line Ls for each scanning frame Fs can be integrated after sufficiently absorbing the shift in the sensing position, which is a concern as the traveling speed increases, according to the shift of the same region ROI. Therefore, it is possible to secure reliability of the sensing data Ds with high resolution compatible with a high frame rate, and to improve the sensing accuracy.

### Fourth Embodiment

A fourth embodiment is still another modification of the first embodiment.

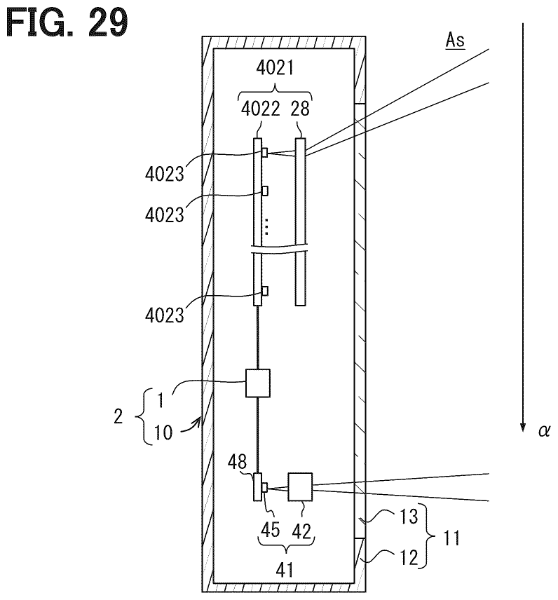

As shown in FIG. 29, an irradiation module 4021 according to the fourth embodiment includes, in addition to the irradiation optical system 28 similar to that of the first embodiment, a light emitting unit 4022 in which an arrangement form of multiple light emitting sources 4023 is different from that of the first embodiment.

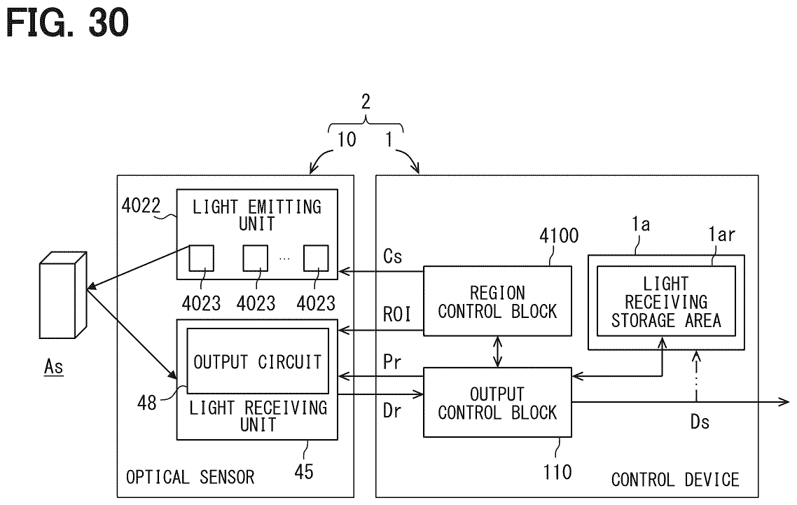

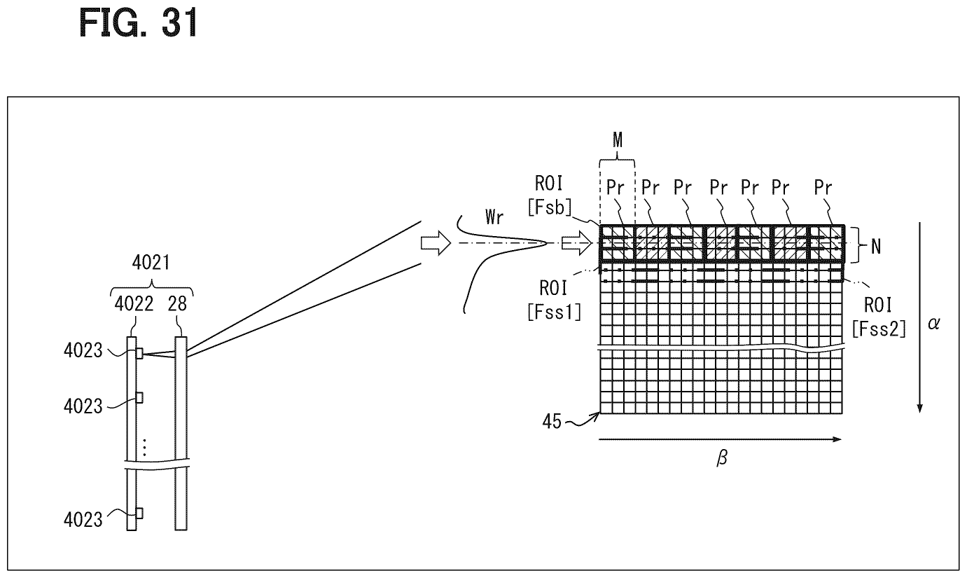

Accordingly, a region control block 4100 according to the fourth embodiment shown in FIG. 30 generates the light emitting control signal Cs for each scanning line Ls of each scanning frame Fs in order to control sequential light emission of each light emitting source 4023 in the light emitting unit 4022 in synchronization with control of the region of interest ROI. At this time, in each scanning frame Fs, the multiple light emitting sources 4023 which are light emitting targets for each scanning line Ls are arranged in the vertical direction corresponding to the scanning direction α so that a common light emitting source 4023 emits light for the region of interest ROI of the same ordinal number. As shown in FIG. 31, a configuration for receiving the reflected light is constructed in each light emitting source 4023 and the irradiation optical system 28 with a non-uniform waveform Wr whose foot is wider on a shift side in the scanning direction α than on an opposite side from a peak aligned with the representative position prr of the light receiving pixel Pr in the reference frame Fsb.

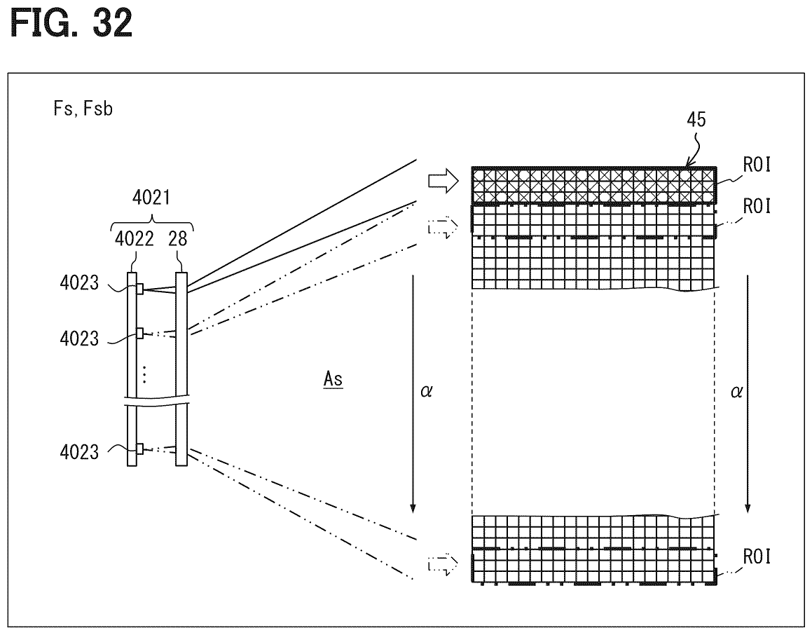

As shown in FIG. 32, the reflected light is guided to the region of interest ROI of each ordinal number which is sequentially shifted for each scanning line Ls in the reference frame Fsb, in response to the irradiation light sequentially emitted by each individual light emitting source 4023. At this time, in the region of interest ROI of each ordinal number, as shown by cross-hatching in FIG. 32, the reflected light is received by all of the N rows of the light receiving element rows 47.

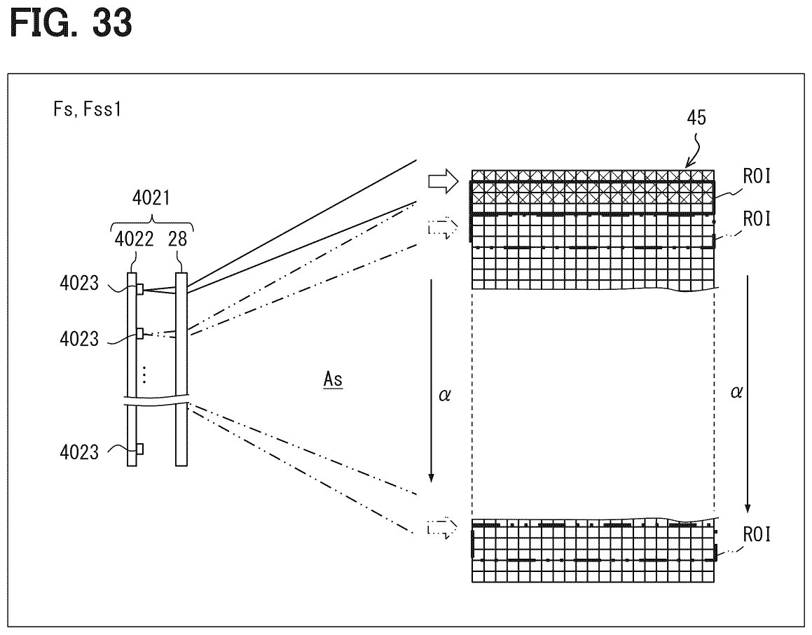

As shown in FIG. 33, the reflected light is guided to the region of interest ROI of each ordinal number which is sequentially shifted for each scanning line Ls in the shift frame Fss1, in response to the irradiation light sequentially emitted by each individual light emitting source 4023. At this time, in the region of interest ROI of each ordinal number, as shown by cross-hatching in FIG. 33, the reflected light is received by two rows of the light receiving element rows 47, each of which is (N−1) rows or less.

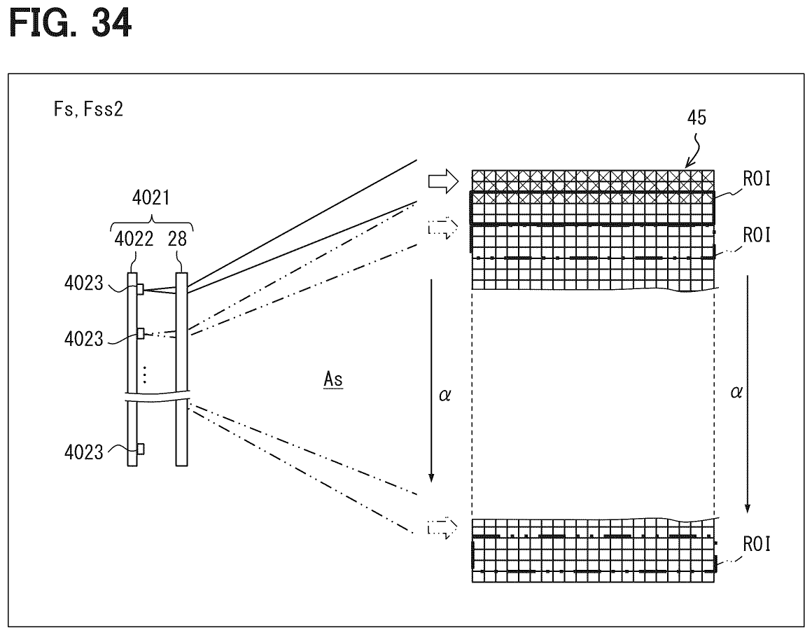

As shown in FIG. 34, the reflected light is guided to the region of interest ROI of each ordinal number which is sequentially shifted for each scanning line Ls in the shift frame Fss2, in response to the irradiation light sequentially emitted by each individual light emitting source 4023. At this time, in the region of interest ROI of each ordinal number, as shown by cross-hatching in FIG. 34, the reflected light is received by one row of the light receiving element row 47, each of which is (N−1) rows or less.

In the fourth embodiment, in S102 of the control flow, the region control block 4100 synchronously controls the sequential shift of the region of interest ROI and the sequential switching of each light emitting source 4023 for each scanning line Ls of the scanning frame Fs corresponding to the index i. At this time, in the reference frame Fsb of i=0, the region control block 4100 causes the light emitting sources 4023 to sequentially emit light in accordance with the region of interest ROI of each ordinal number, which is sequentially controlled to each reference position. On the other hand, in the shift frame Fss1 of i=1, the region control block 4100 causes the light emitting sources 4023 to sequentially emit light in accordance with the region of interest ROI of each ordinal number, which is sequentially controlled to a position shifted by one row of the light receiving element row 47 from the reference frame Fsb. Further, in the shift frame Fss2 of i=2, the region control block 4100 causes the light emitting sources 4023 to sequentially emit light in accordance with the region of interest ROI of each ordinal number, which is sequentially controlled to a position shifted by one row of the light receiving element row 47 from the shift frame Fss1.

In S102 of such a control flow, the reading of the light receiving data Dr in response to the light reception is controlled by the output control block 110 as in the first embodiment. According to the fourth embodiment as described above, with reference to the region of interest ROI in the reference frame Fsb, the number of shift rows of the light receiving element rows 47 in the region of interest ROI in the shift frames Fss1 and Fss2 is controlled to be (N−1) rows or less. In the reference frame Fsb, the light receiving data Dr read in response to the light reception by all of the N rows of the light receiving element rows 47 for each scanning line Ls and the light receiving data Dr read in response to the light reception by (N−1) rows or less of the light receiving element rows 47 for each scanning line Ls in the shift frames Fss1 and Fss2 are integrated. According to this, the light receiving data Dr read from the region of interest ROI for each scanning line for each scanning frame Fs can be integrated while reducing light reception saturation in the light receiving element row 47 in the same region ROI. Therefore, it is possible to increase a dynamic range of the sensing data Ds in addition to improving sensing accuracy due to a high frame rate and high resolution.

While multiple embodiments are described above, the present disclosure is not interpreted as being limited to the embodiments and can be applied to various embodiments and combinations without departing from the gist of the present disclosure.

In the modifications of the first to fourth embodiments, a dedicated computer constituting the control device 1 may include at least one of a digital circuit and an analog circuit as a processor. The digital circuit is at least one type of, for example, an application specific integrated circuit (ASIC), a field programmable gate row (FPGA), a system on a chip (SOC), a programmable gate row (PGA), a complex programmable logic device (CPLD), and the like. Such a digital circuit may also include a memory in which a program is stored.

In the modification of the first to fourth embodiments, the number of rows N of the light receiving element rows 47 constituting the region of interest ROI, which is the number of frames that is the integration unit of the scanning frame Fs, may be two or four or greater. Here, when the number of frames of the integration unit is 2 which is the same as N, the shift frame Fss2 may be omitted. When the number of frames of the integration unit is four or greater, which is the same as N, the scanning frames Fs in which the number of shift rows of the region of interest ROI with respect to the reference frame Fsb is different from those in the shift frames Fss1 and Fss2 may be integrated.

In a modification of the first to fourth embodiments, particularly in a modification of the third embodiment in which the shift in the sensing position can be absorbed and integrated by the shift according to the traveling speed, the compensation of the sensing position according to the traveling speed in S103 to S105 may be omitted. In a modification of the third embodiment, the determination result of the traveling speed may be switched in response to the traveling speed changing from within or out of the determination speed at a timing at which one of the shift frames Fss1 and Fss2 is executed.

In a modification of the third embodiment, by employing the light emitting unit 22 according to the first embodiment instead of the light emitting unit 2022 according to the second embodiment, an individual light emitting source 23 may also be associated with the region of interest ROI in which the number of shift rows increases according to the traveling speed that is out of the determination speed range. In a modification of the third embodiment, the light emitting unit 4022 according to the fourth embodiment is adopted instead of the light emitting unit 2022 according to the second embodiment, so that the light emitting source 4023 common to the region of interest ROI having the same ordinal number may be different between the case in which the traveling speed is within the determination speed range and the case in which the traveling speed is out of the determination speed range, or may be common.

In the modifications of the first to fourth embodiments, the scanning direction α may be set to the horizontal direction outside and inside the optical sensor 10. In this case, the read direction β of the light receiving unit 45 may be set in the vertical direction or the corresponding inclination direction inside the optical sensor 10. In the modifications of the first to fourth embodiments, the irradiation optical system 28 may be implemented mainly by a scanning device such as a liquid crystal scanner capable of controlling the irradiation direction of the irradiation light by the control device 1.

In the modifications of the first to fourth embodiments, the vehicle 5 to which the sensing system 2 is applied may be, for example, an autonomous traveling robot capable of carrying a load or collecting information by autonomous traveling or remote traveling. In addition to the above description, the control device 1 according to the embodiments and the modifications described above may be implemented in the form of a semiconductor device (for example, a semiconductor chip or the like) that is implemented to be mountable on the vehicle 5 and has at least one processor 1b and at least one memory 1a.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A control device configured to control an optical sensor that receives reflected light in response to light irradiation along each scanning line which moves in a scanning direction within a scanning frame, the control device comprising:
a processor configured to carry out
shifting a region of interest between two successive scanning frames, the region of interest being a region from which light receiving data is read for each scanning line, the region of interest corresponding to N rows of light receiving elements stacked in the scanning direction in the optical sensor, N being an integer greater than or equal to 2, the shifting of the region of interest being shifting the region of interest for each scanning line by N−1 or fewer rows of light receiving elements between two successive scanning frames, and
outputting sensing data by integrating the light receiving data of each scanning line retrieved from current and previous N−1 scanning frames.

2. The control device according to claim 1, wherein
the outputting of the sensing data includes correcting a sensing position of the light receiving data according to a traveling speed of a vehicle provided with the optical sensor before the integrating of the light receiving data.

3. The control device according to claim 1, wherein
the shifting of the region of interest includes increasing number of rows of light receiving elements by which the region of interest is shifted between two successive scanning frames, according to increase in traveling speed of a vehicle provided with the optical sensor.

4. The control device according to claim 1, wherein
the outputting of the sensing data includes integrating the light receiving data read through light reception by all the N rows of light receiving elements of each scanning line in each scanning frame.

5. The control device according to claim 1, wherein
the shifting of the region of interest includes controlling number of rows of light receiving elements, by which the region of interest is shifted from a reference frame to a shift frame, to be N−1 or less, the reference frame being one of the two successive scanning frames, the shift frame being another of the two successive scanning frames, and
the outputting of the sensing data includes integrating the light receiving data read through light reception by all the N rows of light receiving elements of each scanning line in the reference frame and the light receiving data read through light reception by N−1 rows or less of light receiving elements of each scanning line in the shift frame.

6. The control device according to claim 1, wherein
the region of interest includes a light receiving pixel which serves as a unit for reading the light receiving data, each row of the light receiving elements having a set number of light receiving elements forming the light receiving pixel, and
the outputting of the sensing data includes integrating the light receiving data read from the light receiving pixel in the region of interest of each scanning line in each scanning frame.

7. The control device according to claim 1, wherein
the outputting of the sensing data includes storing the sensing data by outputting the sensing data to a storage medium.

8. A sensing system comprising:
an optical sensor configured to receive reflected light in response to light irradiation along each scanning line which moves in a scanning direction within a scanning frame; and
the control device according to claim 1 and configured to control the optical sensor.

9. A control method to be executed by a processor for controlling an optical sensor configured to receive reflected light in response to light irradiation along each scanning line which moves in a scanning direction within a scanning frame, the method comprising:
shifting a region of interest between two successive scanning frames, the region of interest being a region from which light receiving data is read for each scanning line, the region of interest corresponding to N rows of light receiving elements stacked in the scanning direction in the optical sensor, N being an integer greater than or equal to 2, the shifting of the region of interest being shifting the region of interest for each scanning line by N−1 or fewer rows of light receiving elements between two successive scanning frames; and
outputting sensing data by integrating the light receiving data of each scanning line retrieved from current and previous N−1 scanning frames.

10. A non-transitory computer readable medium storing control program to control an optical sensor configured to receive reflected light in response to light irradiation along each scanning line which moves in a scanning direction within a scanning frame, the control program comprising commands configured to, when executed by a processor, cause the processor to carry out:
shifting a region of interest between two successive scanning frames, the region of interest being a region from which light receiving data is read for each scanning line, the region of interest corresponding to N rows of light receiving elements stacked in the scanning direction in the optical sensor, N being an integer greater than or equal to 2, the shifting of the region of interest being shifting the region of interest for each scanning line by N−1 or fewer rows of light receiving elements between two successive scanning frames, and
outputting sensing data by integrating the light receiving data of each scanning line retrieved from current and previous N−1 scanning frames.
